(19) United States
(12) Patent Application Publication
(10) Pub. No.: US 2004/0208556 A1
(43) Pub. Date: Oct. 21, 2004

(54) Optical network with high density, signaled sources at the edge of the network

(76) Inventors: Robert Joly, Stittsville (CA); Ali Langari, Toronto (CA); Rob Brennan, Pakenham (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/043,332

(22) Filed: Jan. 14, 2002

(51) Int. Cl. H04B 10/20; H04J 14/00; H04J 4/00

(52) U.S. Cl. 398/57

(57) ABSTRACT

Disclosed is a novel method of allocating resources within an optical network in order to establish an optical path between a first node and a second node. A query signal, proposing a wavelength and timeslot pairing is sent to switching elements along a proposed optical path from the first node to the second node. The query signal is provided along with data indicating the availability of the switching elements along the proposed path. The query signal and data are used to determine an appropriate wavelength and timeslot pairing. When a wavelength and timeslot pairing has been chosen the appropriate switching elements are instructed to support the wavelength timeslot pairing along the optical path.

### FIELD OF THE INVENTION

The invention relates generally to optical signal switching and more particularly to an optical switch architecture having a high degree of flexibility.

### BACKGROUND OF THE INVENTION

Transport networks are wide area networks that provide connectivity for aggregated traffic streams. Modern transport networks increasingly employ wavelength division multiplexing (WDM) technology to utilize the vast transmission bandwidth of optical fibre. WDM is based on transmission of data within different optical signals each within a different wavelength channel on a same fibre. Presently, WDM is mainly employed as a point-to-point transmission technology. In such networks, optical signals within each wavelength channel are converted to electrical signals at each network node.

On the other hand, WDM optical networking technology, which has been developed within the last decade, and which is becoming commercially available employs data signals within a fixed wavelength channel on an end-to-end basis, without electrical conversion in the network. See, for example, Alexander, S. B., et al, “A precompetitive consortium on wide-band all-optical networks,” J. of Lightwave Tech., Vol. 11, pp714-735, May, 1993; Chang, G. K., et al, “Multiwavelength reconfigurable WDM/ATM/SONET network testbed,” J. of Lightwave Tech., vol. 14, pp. 1320-1340, June, 1996; Wagner, R. E., et al, “MONET: Multiwavelength optical networking,” IEEE J. of Lightwave Tech., Vol. 14, pp. 1349-1355, June, 1996.

Provisioning of a transport network refers to assigning network resources to a static traffic demand. Efficient provisioning is essential in minimizing the investment made on a network required to accommodate a given demand. In the context of WDM optical networks, provisioning means routing and wavelength selection for a set of end-to-end wavelength channel allocation demands, given a demand distribution and a network topology. Provisioning of WDM networks has been a subject of considerable interest, concentrating primarily on two context categories. The first of these addresses the case of limited deployed fibre, where provisioning seeks to minimize the number of required wavelength channels. Such applications are described, e.g., in Chlamtac, I., A. Ganz, and G. Karmi, “Lightpath communications: An approach to high bandwidth optical WAN's,” IEEE Transactions on Communications, Vol. 40, No. 7, pp. 1171-1182, July, 1992, and Nagatsu, N., Y. Hamazumi, and K. Sato, “Electronics and Communications in Japan,” Part 1, Vol. 78, No. 9, pp. 1-11, September 1995. The second case that has been addressed in the prior art is that involving a limited number of wavelengths per fibre, where provisioning seeks to minimize the amount of required fibre. See, for example, Nagatsu, N., and K. Sato, “Optical path accommodation design enabling cross-connect system scale evaluation,” IEICE Trans. Commun, Vol. E78-B, No. 9, pp. 1339-1343, September, 1995; and Jeong, G. and E. Ayanoglu, “Comparison of wavelength-interchanging and wavelength-selective cross-connects in multiwavelength all-optical networks,” Proc. IEEE INFOCOM '96, pp. 156-163, March, 1996.

In a typical network in which provisioning is applied, there is a set of nodes interconnected by a plurality of fibre links to form a network. It is assumed that each connection between any two nodes requires a dedicated wavelength channel on each link of its path. The typical context assumes that there is a fixed set of wavelength channels available on each fibre, and therefore the connections are established at the expense of possibly multiple fibres on network links. Each fibre has a cost reflecting the installed fibre material, optical amplifiers, and optical termination equipment at both ends of the link. The objective of provisioning is taken as the minimization of the total network cost. Most prior attempts at provisioning for networks have sought an optimal solution prescribing how such provisioning should be accomplished. Of course, the term node as used herein is somewhat arbitrary and sometimes, wavelength conversion, via an opto-electro-opto conversion, occurs between nodes. Though this is sometimes stated, clearly the case of opto-electro conversion can be considered a network node even if no network interface port is supported at that node.

A first class of prior provisioning solutions is applied in networks that do not account for possible network failures. Such networks are called primary networks; the objective in primary-network design is to minimize the cost associated with the working fibres. This problem has typically been formulated as an integer linear program (ILP) in a straightforward manner. However, the computational complexity of such ILP solutions has proven to be prohibitive for a network whose size is not trivial.

Moreover, since transport networks are intended to carry high volumes of traffic, network failures can have severe consequences. This imposes fault-tolerance as an important feature for provisioning practical transport networks. Fault-tolerance refers to the ability of the network to reconfigure and reestablish communication upon failure, and is widely known as restoration. Restoration entails rerouting connections around failed components in less than a targeted time-to-restore. A network with restoration capability requires redundant capacity to be used in the case of failures. An important concern in designing and provisioning such networks is to provide robustness with minimal redundancy.

While design methods devised for conventional, single-wavelength channel restorable networks can be employed in WDM optical networks, such prior designs typically prescribe switching all wavelengths in a fibre together in the case of failure. WDM optical networking, however, can support the capability to switch signals within different wavelength channels individually, thereby offering a richer set of design options. Some attempts at employing this flexibility have been put forward, for example, in Nagatsu, N., S. Okamoto, and K. Sato, “Optical path cross-connect scale evaluation using path accommodation design for restricted wavelength multiplexing,” IEEE JSAC, Vol. 14, No. 5, pp. 893-901, June, 1996; Sato, K. and N. Nagatsu, “Failure restoration in photonic transport networks using optical paths,” Proc. of OFC '96, pp. 215-216, March, 1996; and Wuttisittikuikij, L., and M. J. O'Mahony, “Use of spare wavelengths for traffic restoration in multi-wavelength transport network,” Proc. of ICC '95, PP. 1779-1792, June, 1992.

Solutions for provisioning WDM networks with restoration have, nevertheless, proven complex and time consuming. Further, in the case of failure a provisioning system must account for a complicated reassignment of routing.

Alternatively, other network architectures feature equipment that decodes individual optical packets, reads contents of each packet to determine a correct destination node therefore and transmits the packet to the correct destination node. The typical method of reading the contents of the packet involves converting the optical data signal to electrical data and detecting packets therein. Once detected, the packet is buffered within the opto-electro-opto (OEO) converter. Sending the packet then requires that the electrical data be converted back to an optical packet. This conversion step is commonly referred to as an optical to electrical to optical or OEO conversion. The equipment required to perform the OEO conversion is very expensive and unlike passive optical components the equipment used in the OEO conversion is sensitive to high bitrates. If the bitrate of an optical data stream is increased beyond the working range of the OEO converter then a new OEO converter is required. While the OEO converter assists with bandwidth allocation within a network, it is limited by bitrate sensitivity and cost.

Since the OEO conversion is expensive other network architectures have been developed. An alternative network architecture allows wavelength channels to be assigned until released. When a significant change in the demand for bandwidth between the various nodes of a network is experienced the network is capable of being reconfigured to provide additional wavelength channels for those routes between the nodes experiencing higher usage once the additional wavelength channels are released. In this case, a network element requests additional wavelength channels and receives a response when the resources are available. The network element releases the resources when it no longer has need for them. This type of network offers most of the flexibility of the network featuring OEO converters without the cost. Unfortunately, this network architecture is not immediately configurable. Consequently, it is unable to take full advantage of the maximum available data communication capacity within a wavelength channel. For example if a first node is tasked to provide data to a second node where the data is a continuous stream of data then the wavelength channel is left continuously available to the first and second nodes, even though the data stream might require only a small percentage of the available communication capacity of the wavelength channel. Other nodes needing to use the same wavelength channel within a same route wait. In comparison, the previous prior art network using OEO is able to buffer packets—small amounts of data grouped together—from the stream of data and send them independently thereby allowing a wavelength channel to be used within other routes as well. Clearly, it would be beneficial to have a network architecture that is as flexible as an OEO based network architecture without the OEO costs.

A more dynamic method of routing data within all optical networks would be highly advantageous. Unfortunately, approaches that are highly flexible typically employ an opto-electronic conversion to allow for wavelength shifting, buffering, and rerouting of data.

### OBJECT OF THE INVENTION

In order to overcome these and other limitations of the prior art, it is an object of the present invention to provide a switch architecture supporting switching of light signals at predetermined wavelengths generated outside the switching fabric.

It is a further object of the invention to provide a network switching architecture supporting burst optical data traffic.

It is also a further object of the invention to provide a data routing process that is easily utilized with existing optical networks thereby allowing service providers to continue to use existing equipment with minimal disruption of service.

It is another object of the invention to provide a data routing process that supports increased efficiency of bandwidth utilization.

### SUMMARY OF THE INVENTION

In an attempt to overcome these and other limitations of the prior art, there is provided a method of routing data within an optical network comprising the steps of: providing data at a first node for transmission to a second other node; providing a first query signal proposing at least a timeslot/wavelength channel pairing for data transmission of the provided data; receiving the query signal and data relating to availability of switching elements disposed within an optical communication path between the first node and the second other node; selecting one of the proposed timeslot/wavelength channel pairings for the data transmission; and, providing a command signal to each switching element requiring configuration to allow said elements to be configured for the selected timeslot/wavelength channel pairing to support communication from the first node to the second node of the provided data.

Further, a method of routing data within an optical network is provided comprising the steps of: providing data at a first node for transmission to an other node; providing a first query signal to the second other node; at the second other node, selecting a timeslot/wavelength channel pairing for the data transmission absent predetermined knowledge that the timeslot/wavelength channel pairings is available for the transmission; and, providing a command signal to each element requiring configuration to allow said elements to be configured for the selected timeslot/wavelength channel pairing to support communication from the first node to the second node of the provided data.

The invention also provides a method of routing optical data within an optical network comprising the steps of: absent a priori knowledge of a fixed communication timeslot/wavelength channel pairing between nodes or of a known available route between nodes, generating a first optical signal within a known timeslot/wavelength channel pairing at a first node and destined for a second other node; providing the first optical signal to a switching fabric; routing the first optical signal within the switching fabric to the second other node; and, receiving the first optical signal at the second other node.

Additionally, there is disclosed a method of routing optical data within an optical network comprising the steps of: providing an optical wavelength switch having switching setup times of substantially less than one millisecond; providing an optical source for generating optical signals within any of a plurality of different optical wavelength channels, the optical source capable of transmitting optical signals within two different wavelength channels spaced in time by substantially less than one millesecond; determining a proposed timeslot/wavelength channel pairing from a first node and destined for a second other node, the proposed timeslot/wavelength channel pairing other than a known available timeslot/wavelength channel pairing; setting up the optical wavelength switch for the determined proposed timeslot/wavelength channel pairing; generating, using the optical source, a first optical signal within the determined timeslot/wavelength channel pairing at the first node and destined for the second other node; providing the first optical signal to the optical wavelength switch; and, when the timeslot/wavelength channel pairing is available routing the first optical signal within the switching fabric to the second other node.

### BRIEF DESCRIPTION OF THE DRAWINGS

The invention will now be described with reference to the attached drawings in which:

FIG. 1 is a simplified network diagram;

FIG. 2 is a simplified network diagram of another network topology;

FIG. 3 is a simplified network diagram of another network topology;

FIG. 4 is a simplified network diagram of another network topology;

FIG. 5 is a simplified network topology for use in describing the inventive process;

FIG. 6 is a timing diagram showing an optical signal traversing an all-optical data network;

FIG. 7 is a timing diagram showing a signal traversing other than an all optical network;

FIG. 8 is a timing diagram of a method according to the invention;

FIG. 9 is a timing diagram of an alternative method according to the invention;

FIG. 10 is a flow diagram of a method according to the invention wherein timeslots are reserved on the forward pass;

FIG. 11 is a flow diagram of a method according to the invention wherein the configuration data is transmitted in a counter-proagating fashion;

FIG. 12 is a simplified flow diagram of a method according to the invention wherein timeslots remain unreserved after the forward configuration signal has passed;

FIG. 13 is a flow diagram of a method according to the invention wherein the configuration data is transmitted in a counter-proagating fashion;

FIG. 14 is a flow diagram of a method according to the invention wherein wavelength channels are reserved on the forward pass;

FIG. 15 is a flow diagram of a method according to the invention wherein the configuration data is transmitted in a counter-proagating fashion;

FIG. 16 is a simplified flow diagram of a method according to the invention wherein wavelength channels remain unreserved after the forward configuration signal has passed;

FIG. 17 is a flow diagram of a method according to the invention wherein the configuration data is transmitted in a counter-proagating fashion;

FIG. 18 is a simplified network diagram including a wavelength converter;

FIG. 19 is a simplified network diagram including an opto-electro-opto (OEO) conversion component;

FIG. 20 is a simplified network block diagram showing a network supporting different routing paths between a first node and a second node;

FIG. 21 is a simplified network diagram of a network having a high bandwidth portion and second other low bandwidth portion;

FIG. 22 is a simplified network diagram of a network having a high bandwidth portion and second other low bandwidth portion;

FIG. 23 is a simplified network diagram of a network having a dedicated query and decision node therein;

FIG. 24 is a simplified diagram of a timing diagram showing non-contiguous timeslots;

FIG. 25 is a simplified diagram of a network comprising three sub-networks;

FIG. 26 is a simplified flow diagram of a method according to the invention;

FIG. 27 is a simplified flow diagram of an alternative method according to the invention;

FIG. 28 is a simplified flow diagram of another alternative method according to the invention;

FIG. 29 is a simplified block diagram of a 4×4 switch fabric; and,

FIG. 30 is a simplified block diagram of an optical network that includes a prior art ring network.

### DETAILED DESCRIPTION OF THE INVENTION

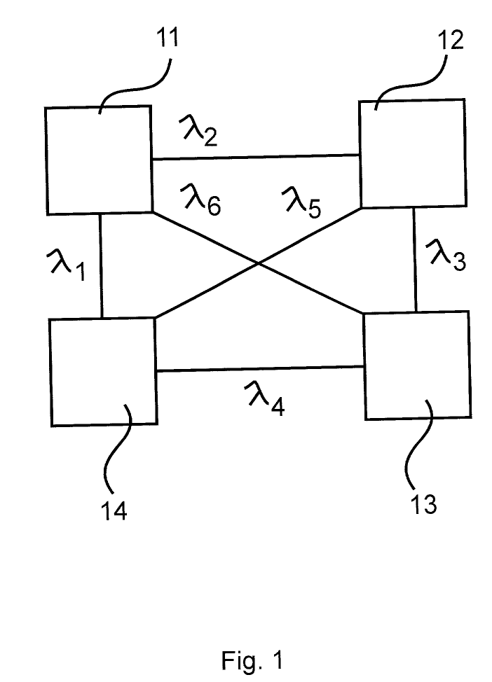

Referring to FIG. 1, a prior art optical data network is shown wherein 4 nodes 11, 12, 13, and 14 are each provided with dedicated fixed optical wavelength channels therebetween. Such an architecture provides for guaranteed service between nodes. Unfortunately, this guarantee comes at a cost of network configuration rigidity. Clearly, for each node pair requiring communication therebetween, an optical wavelength channel is dedicated. Further, even if a small amount of bandwidth is required between two nodes, an entire wavelength channel is provided.

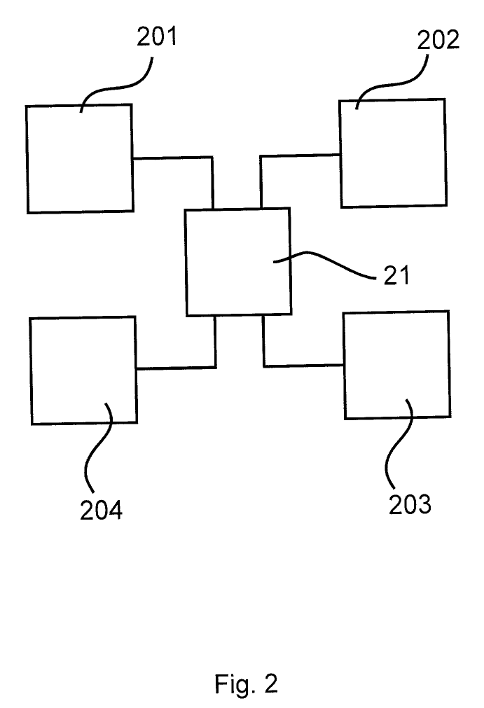

To overcome the limitations of the architecture of FIG. 1, the architecture shown in FIG. 2 can be used. Here a server 21 provides a dedicated optical link therefrom to each node 201, 202, 203, and 204 of the network. The nodes transmit data modulated on optical signals and the server acts to receive each optical data signal and route it to its destination. Routing is performed using a step of OEO conversion. The network is bandwidth limited by the server—a faster server supports a faster network and a slower server supports a slower network. Also, the network requires that the server detect optical signals, analyse them to determine a destination and regenerate the signals directed toward a correct destination node. Unfortunately, such an architecture results in significant network reliability concerns since the network reliability is only as good as the server reliability.

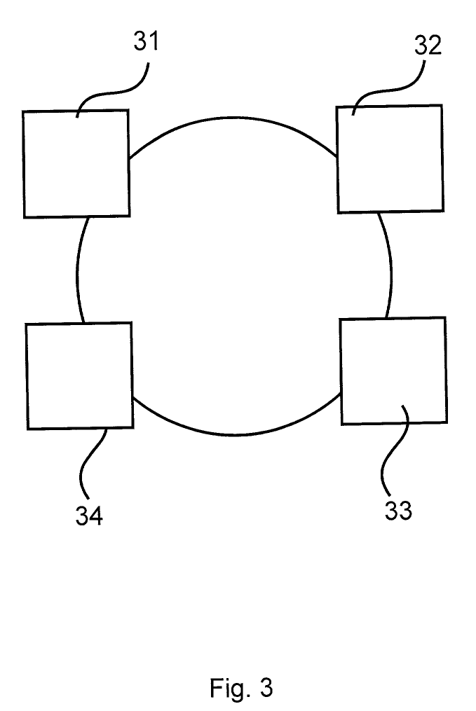

Referring to FIG. 3, another network topology is shown wherein data from each node 31, 32, 33, and 34 to each other node is assigned a time slot within a communication timing. For example, in the ring topology shown, each node is assigned a percentage of the bandwidth and is then provided with timeslices within the carrier signal to transmit on. Such a system is commonly referred to as time division multiplexing (TDM). Also, each port is assigned fixed receive timeslices. In order to transmit a signal from port 31 to port 32 the timeslot within the timeslice intersection of the port 31 transmit and the port 32 receive is used for having the data modulated therein.

Such an architecture allows a single wavelength channel to be divided up to allow for fractional channel bandwidth assignment between nodes. Unfortunately, the fractional channel assignment is somewhat fixed in nature and does not support on-demand network bandwidth requirements.

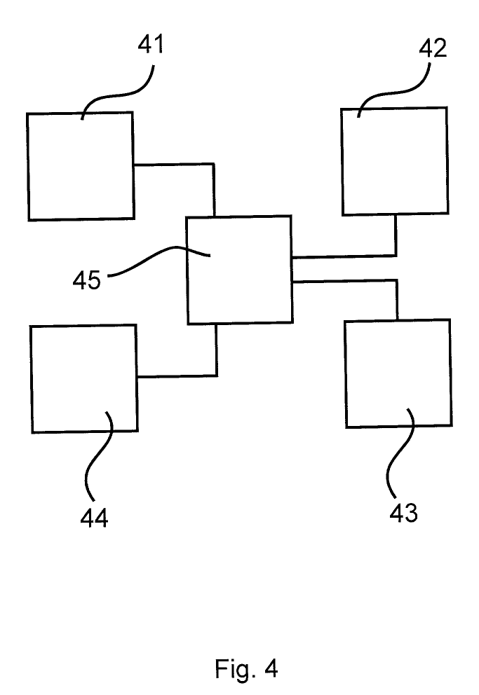

Referring to FIG. 4, another architecture is shown wherein four nodes 41, 42, 43, and 44 communicate one with another on any of a number of wavelength channels via a star coupler 45. Here, two nodes communicating on a same wavelength channel at a same time will result in a data collision causing data corruption. As such, the nodes must be provided with further communication means for allowing them to be configured for communication. Typically, each node is assigned a wavelength channel or a timeslice or both. This allows collisions to be prevented though it causes the same previously described drawbacks as the other prior art topologies.

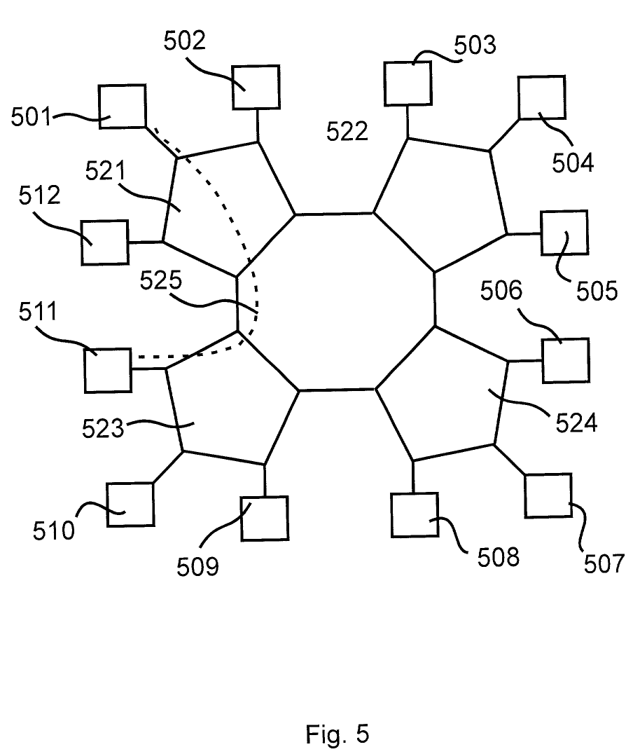

Referring to FIG. 5, shown is an optical network having 12 nodes 501 through 512. The nodes are coupled through all optical switches 521, 522, 523, and 524 such that an optical signal transmitted at any of the nodes is routable to any other node without opto-electro-optical conversion and without wavelength conversion therein. This allows for very little latency between a transmit operation and a receive operation. Unfortunately, such a network is very difficult to design in a node to node all optical fashion using any of the prior art techniques. Clearly, assigning fixed wavelength channels or timeslots is a complex task for multiple internetworking optical switches. An optical path 525 is shown connecting the nodes 501 and 511.

Therefore, in order to achieve such a network architecture, a method for configuring optical pathways between nodes is necessary. Because the time required to reconfigure most prior art switching fabrics is very long in comparison to a burst of optical data, for example, dynamically configurable networks are typically inefficient and provide for long network analysis times to determine switching fabric configurations. Of course, as switching speeds improve, it will become advantageous to support fast switching by supporting dynamic optical burst data routing within the network. The invention provides a method of rapidly configuring an optical network supporting dynamic optical burst data propagation. The invention relies upon a query signal being sent to a set of nodes along various optical paths between the optical signal source and the destination. The propagation of the query signal is described hereinbelow.

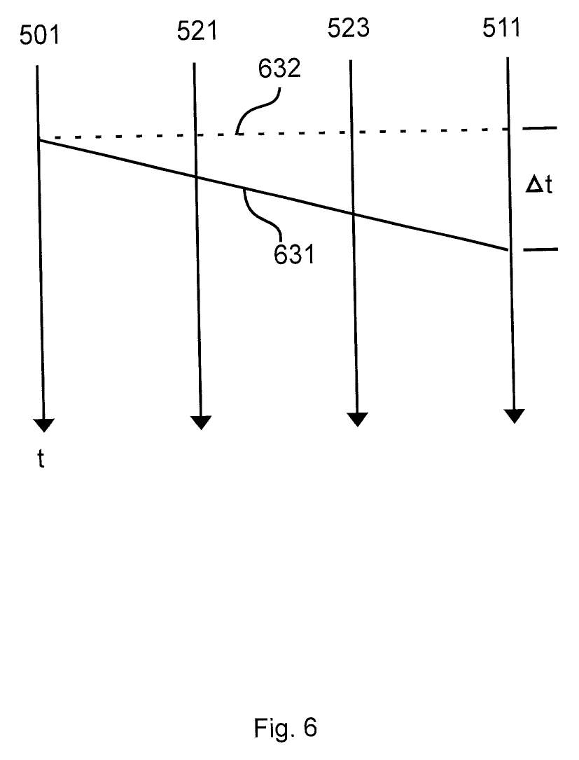

Referring to FIG. 6, a timing diagram is shown for a single optical signal propagating from a first node 501 to a second other node 511. The optical signal passes through a plurality of switching elements 521 and 523. The timelines have earlier times near the top and later times near the bottom. There is a line for each of the two nodes and for each of the three switching elements. The optical signal is represented by a line 631 between two of the time lines indicating propagation of the optical signal. A horizontal line 632 shows events that are simultaneous. As is determinable from the diagram, the propagation delay from node 501 to node 511 is At.

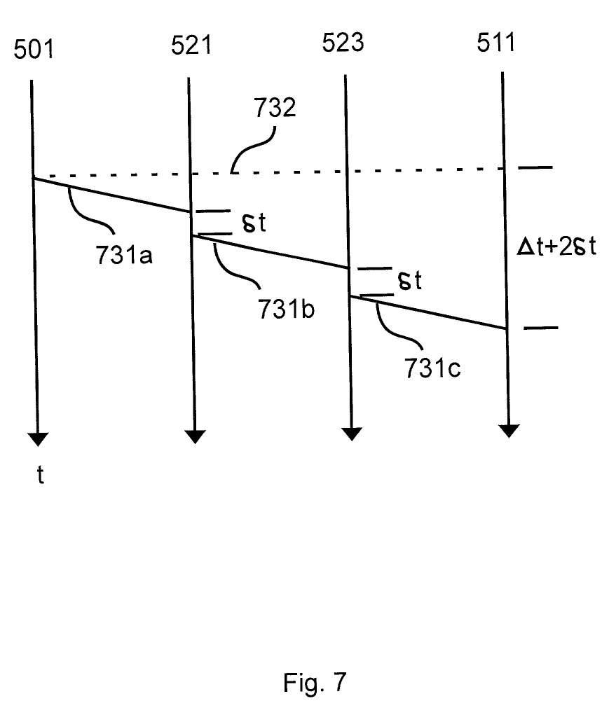

Referring to FIG. 7, a timing diagram is shown for a configuration data signal 731a, 731b, and 731c transmitted between nodes 501 and 511 for being received by the nodes and switching elements. This configuration data signal includes, for example, configuration data for allowing the switching elements, transmitter and receiver to be configured in a co-operative fashion. Here, the configuration data signal is shown with a latency δt at each switching element for the signaling data to be detected and regenerated. Line 732 illustrates events that occur simultaneously. As is evident from an analysis of the diagram, the signal requires more time to propagate from node 501 to 511. Here the time required is Δt+2δt.

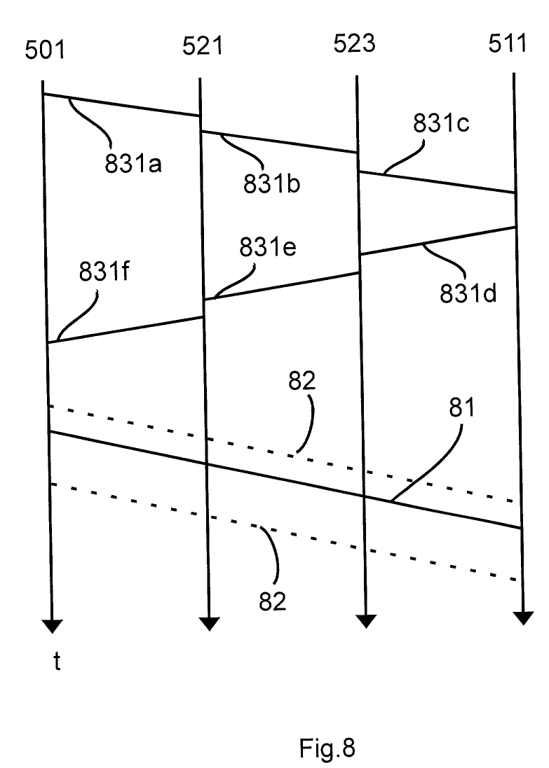

Referring to FIG. 8, a timing diagram is shown for establishing an optical communication path for optical burst data from node 501 to node 511. Here a configuration data signal 831a-831f is transmitted from the node 501 indicating a preferred time slot for transmitting an optical data signal. The preferred time slot shown between the lines 82 is substantially delayed after the configuration data signal has completed propagating from node 501 to node 511 and back to node 501 including detection and regeneration times. The preferred time slot is substantially larger than the timeslot necessary to transmit the burst.

Switching element 521 receives the configuration data signal and reserves the portion of time requested shown between dashed lines 82 when available and indicates portions that are unavailable by updating the signaling data prior to regeneration. The regenerated configuration data signal is transmitted to switching element 523 where a similar set of operations is performed. The re-regenerated configuration data signal is transmitted to the node 511. At node 511, the best timeslot is selected and the receiver is set to receive the indicated data at that time. A data signal indicative of the selected timeslot is generated and transmitted back to node 501. Along the way, each switching element receives the data signal and configures itself accordingly to allow for optical signal propagation. When the data signal is received at node 501, the node is provided with the determined time to transmit the optical signal and transmits the signal 81 accordingly. As is evident, within the optical network the burst requires nominal time to propagate, as there are no OEO conversions or other latencies other than a propagation time for the light. Further, because the network configuration data typically requires significantly less bandwidth than the optical data traffic, such a system is efficient for data communication.

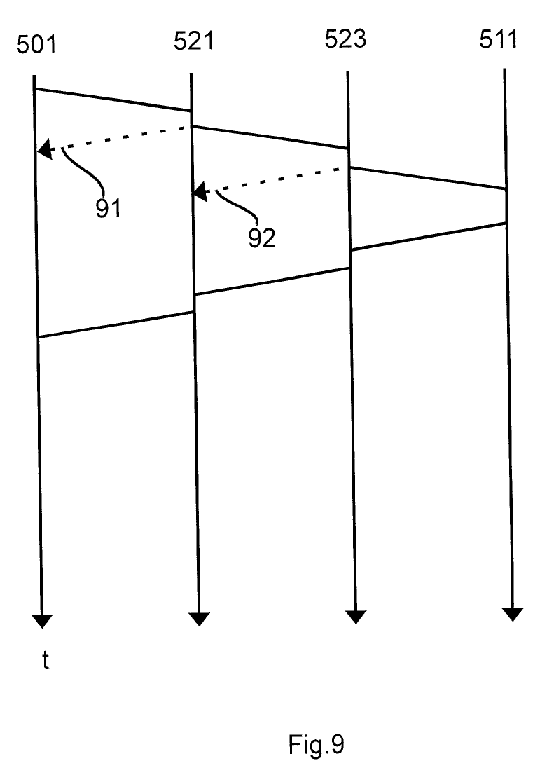

Referring to FIG. 9, a similar diagram to that of FIG. 8 is shown but here, each node additionally transmits an acknowledge signal in a counter propagating fashion to the regenerated signal. This allows other nodes to receive information relating to the progress of the data signal. For example, if switching element 521 is already reserved at the time in question, then the node 501 is informed of same sooner and can free up that portion of the requested timeslot for further transmissions.

Further, when an optical network is of substantial size and many (R) switching elements are interposed between two communicating nodes, the ability to free up portions of reserved timeslots that are not available enhances network performance by (a) supporting more free timeslots at any given point in time since updating of the reserved timeslots occurs more frequently and (b) allowing for requested timeslots to be larger since they are pruned more rapidly and do not have to wait for the original signal to propagate fully through its return path.

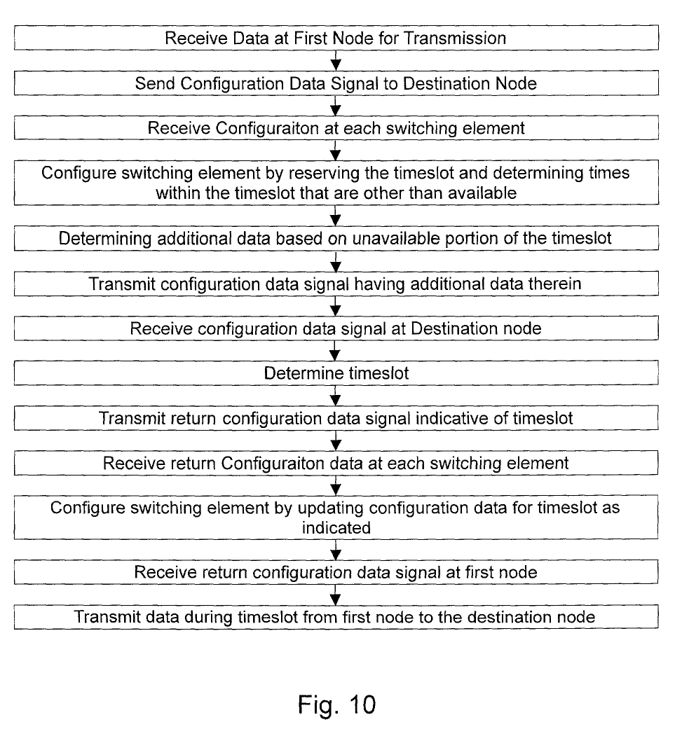

Referring to FIG. 10, a simplified flow diagram of a method according to the invention is shown. In a first step, a first node receives data to transmit to a second other node. A configuration data signal is transmitted from the node to the second other node indicating, for example, an amount of data to be transmitted, a preferred optical path if any, and one or more preferred timeslots during which to transmit the data.

The configuration signal is received by each all-optical switch along the data communication path. At each switch, the signal is received and analysed. The timeslot(s) requested is reserved and those portions of the timeslot that are unavailable are indicated within the message and removed from the timeslot reserved. The configuration data signal is then regenerated and transmitted along its path further.

Once the configuration data signal has reached a destination thereof, the destination node selects a best timeslot of adequate time to receive the data signal and transmits its determination within a return configuration data signal back toward the first node. When the return configuration signal is received at each switching element, the switching element updates its configuration data accordingly to ensure proper configuration for directing the signal at the determined time to the destination node. When the return configuration signal reaches the first node, the first node schedules the data transmission accordingly.

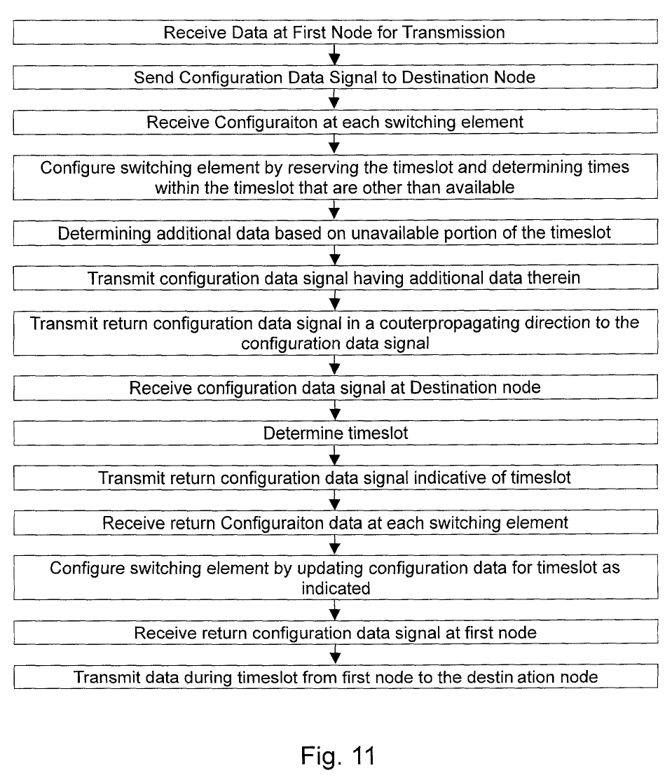

Referring to FIG. 11, a simplified flow diagram of a method according to the invention is shown for use with the timing diagram of FIG. 9. In a first step, a first node receives data to transmit to a second other node. A configuration data signal is transmitted from the node to the second other node indicating, for example, an amount of data to be transmitted, a preferred optical path if any, and one or more preferred timeslots during which to transmit the data.

The configuration signal is received by each all-optical switch along the data communication path. At each switch, the signaling data is received and analysed. The timeslot(s) requested is reserved and those portions of the timeslot that are unavailable are indicated within the message and removed from the timeslot reserved. The configuration data signal is then regenerated and transmitted along its path further toward the second node and back toward the first node. This allows switching elements that have already reserved timeslots to update their reserved timeslots according to other switching element availability. Also, the first node is capable of updating its available transmit timeslots based on freeing up unavailable timeslot portions.

Once the configuration data signal has reached a destination thereof, the destination node selects a best timeslot of adequate time to receive the data signal and transmits its determination within a return configuration data signal back toward the first node. When the return configuration signal is received at each switching element, the switching element updates its configuration data accordingly to ensure proper configuration for directing the signal at the determined time to the destination node. When the return configuration signal reaches the first node, the first node schedules the data transmission accordingly.

Of course, since network topologies are large and complex, some destination nodes are only separated from the first node by one switching element while others are separated by many switching elements and, as such, freeing up of transmission timeslots is beneficial.

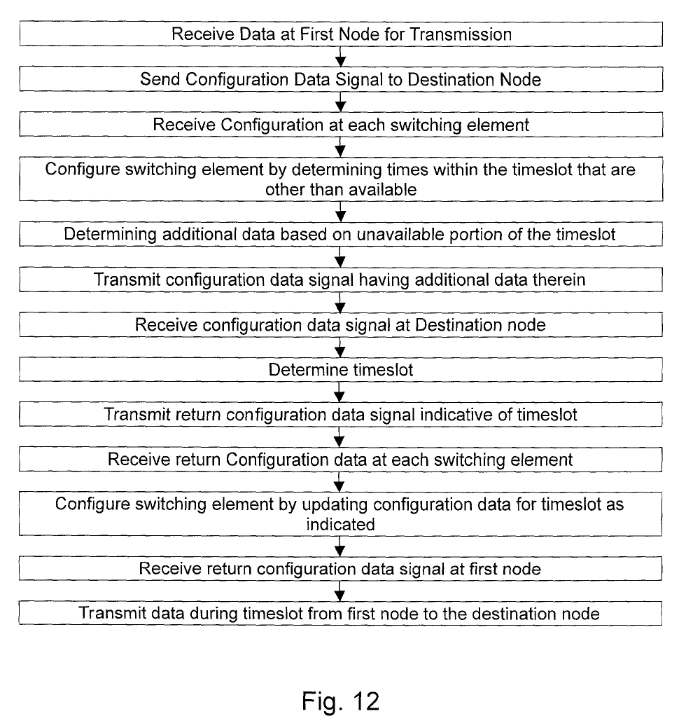

Referring to FIG. 12, a simplified flow diagram of another embodiment of a method according to the invention is shown. In a first step, a first node receives data to transmit to a second other node. A configuration data signal is transmitted from the node to the second other node indicating, for example, an amount of data to be transmitted, a preferred optical path if any, and one or more preferred timeslots during which to transmit the data.

The configuration signal is received by each all-optical switch along the data communication path. At each switch, the signal is received and analysed. The timeslot(s) requested are compared to those available and those portions of the timeslot that are unavailable are indicated within the message. The configuration data signal is then regenerated and transmitted along its path further.

Once the configuration data signal has reached a destination thereof, the destination node selects a best timeslot of adequate time to receive the data signal and transmits its determination within a return configuration data signal back toward the first node. When the return configuration signal is received at each switching element, the switching element updates its configuration data accordingly to ensure proper configuration for directing the signal at the determined time to the destination node. When the return configuration signal reaches the first node, the first node schedules the data transmission accordingly. Of course, if the determined timeslot is already being used at one of the intermediary switching elements, then another configuration signal is needed.

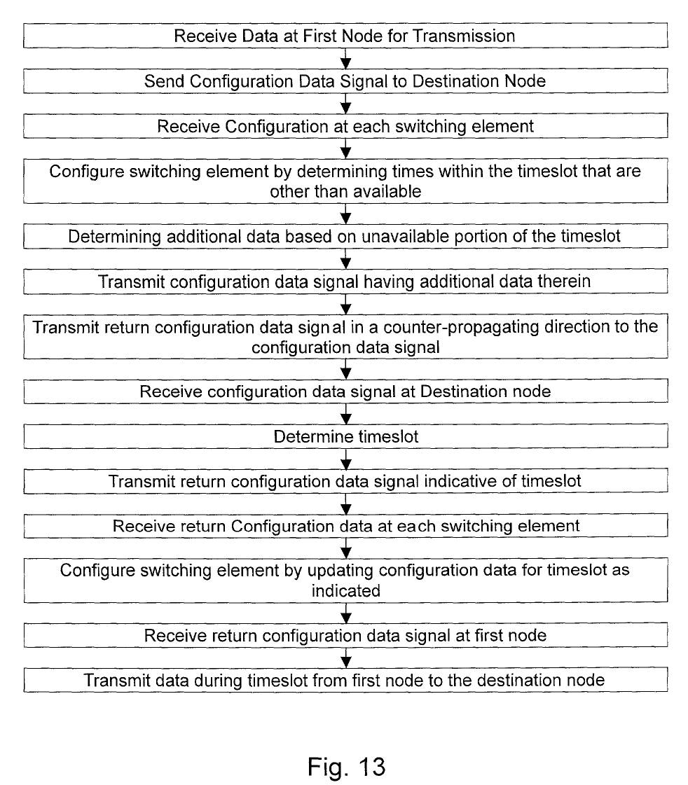

Referring to FIG. 13, a simplified flow diagram of a method according to the invention is shown for use with the timing diagram of FIG. 9. In a first step, a first node receives data to transmit to a second other node. A configuration data signal is transmitted from the node to the second other node indicating, for example, an amount of data to be transmitted, a preferred optical path if any, and one or more preferred timeslots during which to transmit the data.

The configuration signal is received by each all-optical switch along the data communication path. At each switch, the signal is received and analysed. The timeslot(s) requested is analysed and those portions of the timeslot that are unavailable are indicated within the message. The configuration data signal is then regenerated and transmitted along its path further toward the second node and back toward the first node. This allows switching elements that have already been informed of potential use of timeslots to update their timeslot database according to other switching element availability. Also, the first node is capable of updating its available transmit timeslots based on freeing up unavailable timeslot portions.

Once the configuration data signal has reached a destination thereof, the destination node selects a best timeslot of adequate time to receive the data signal and transmits its determination within a return configuration data signal back toward the first node. When the return configuration signal is received at each switching element, the switching element updates its configuration data accordingly to ensure proper configuration for directing the signal at the determined time to the destination node. When the return configuration signal reaches the first node, the first node schedules the data transmission accordingly. Of course, if the determined timeslot is already being used at one of the intermediary switching elements, then another configuration signal is needed.

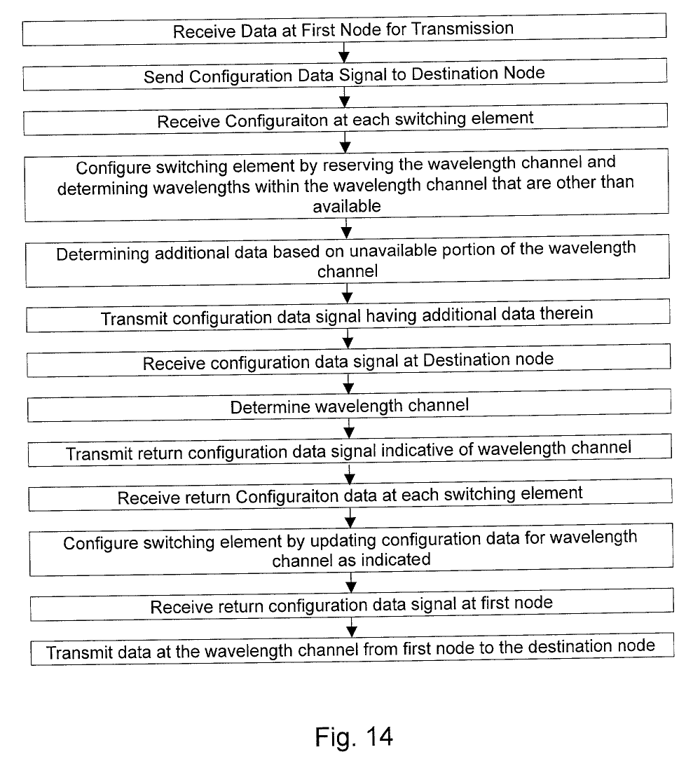

Referring to FIG. 14, a simplified flow diagram of a method according to the invention is shown. In a first step, a first node receives data to transmit to a second other node. A configuration data signal is transmitted from the node to the second other node indicating, for example, an amount of data to be transmitted, a preferred optical path if any, a timeslot in which to transmit the data, and one or more preferred wavelength channels in which to transmit the data.

The configuration signal is received by each all-optical switch along the data communication path. At each switch, the signal is received and analysed. The wavelength channel(s) requested is reserved and those portions of the wavelength channel(s) that are unavailable are indicated within the message and removed from the wavelength channel(s) reserved. The configuration data signal is then regenerated and transmitted along its path further.

Once the configuration data signal has reached a destination thereof, the destination node selects a best wavelength channel(s) within which to receive the data signal and transmits its determination within a return configuration data signal back toward the first node. When the return configuration signal is received at each switching element, the switching element updates its configuration data accordingly to ensure proper configuration for directing the signal at the determined time and for the determined wavelength channel(s) to the destination node. When the return configuration signal reaches the first node, the first node schedules the data transmission accordingly.

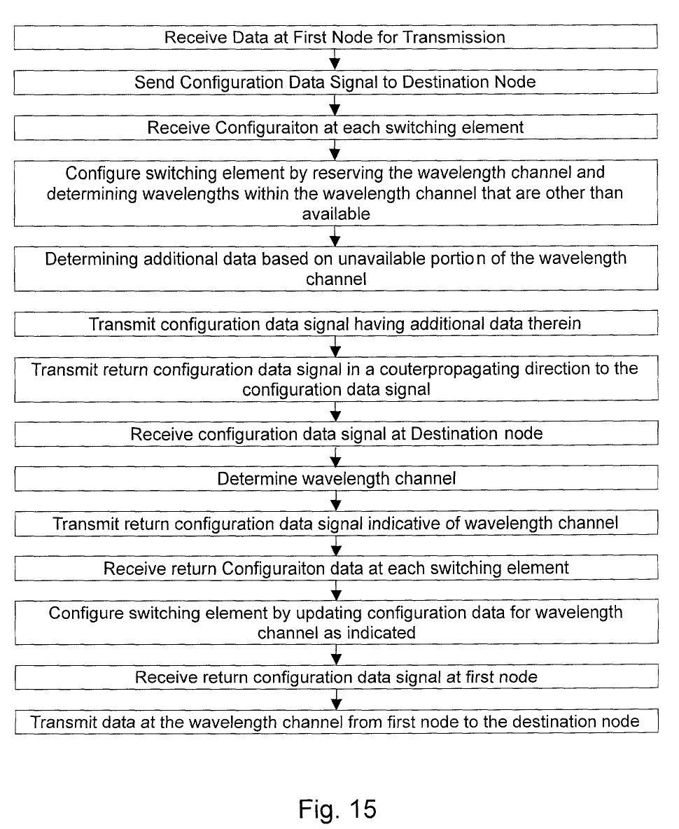

Referring to FIG. 15, a simplified flow diagram of a method according to the invention is shown for use with the timing diagram of FIG. 9. In a first step, a first node receives data to transmit to a second other node. A configuration data signal is transmitted from the node to the second other node indicating, for example, an amount of data to be transmitted, a preferred optical path if any, a timeslot in which to transmit the data, and one or more preferred wavelength channels in which to transmit the data.

The configuration signal is received by each all-optical switch along the data communication path. At each switch, the signal is received and analysed. The wavelength channel(s) requested is reserved and the those wavelength channel(s) that are unavailable are indicated within the message and removed from the wavelength channel(s) reserved. The configuration data signal is then regenerated and transmitted along its path further toward the second node and back toward the first node. This allows switching elements that have already reserved wavelength channel(s) to update their reserved wavelength channel(s) according to other switching element availability. Also, the first node is capable of updating its available transmit wavelength channel(s) based on freeing up unavailable wavelength channel(s).

Once the configuration data signal has reached a destination thereof, the destination node selects a best wavelength channel(s) of adequate time to receive the data signal and transmits its determination within a return configuration data signal back toward the first node. When the return configuration signal is received at each switching element, the switching element updates its configuration data accordingly to ensure proper configuration for directing the signal at the determined time and within the determined wavelength channel(s) to the destination node. When the return configuration signal reaches the first node, the first node schedules the data transmission accordingly.

Of course, since network topologies are large and complex, some destination nodes are only separated from the first node by one switching element while others are separated by many switching elements and, as such, freeing up of transmission wavelength channel(s) is beneficial.

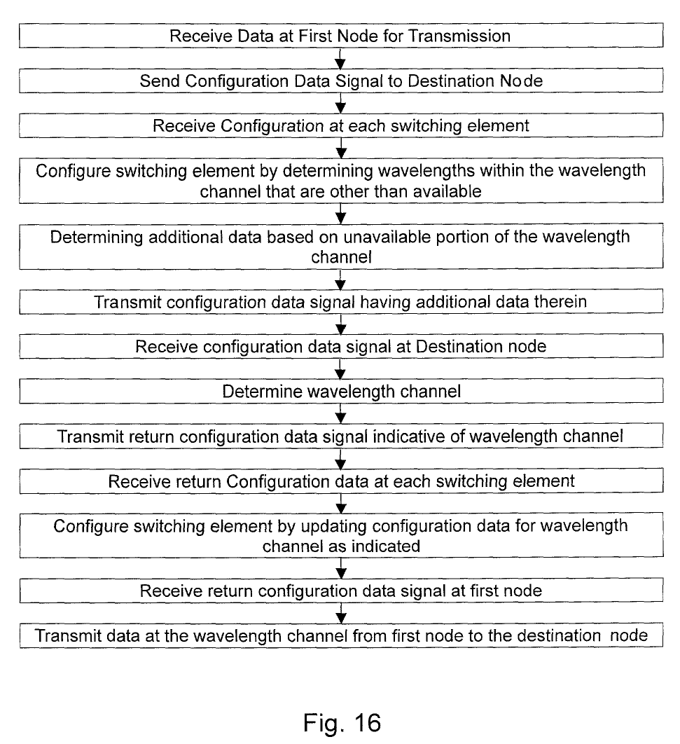

Referring to FIG. 16, a simplified flow diagram of another embodiment of a method according to the invention is shown. In a first step, a first node receives data to transmit to a second other node. A configuration data signal is transmitted from the node to the second other node indicating, for example, an amount of data to be transmitted, a preferred optical path if any, a timeslot in which to transmit the data, and one or more preferred wavelength channels in which to transmit the data.

The configuration signal is received by each all-optical switch along the data communication path. At each switch, the signal is received and analysed. The wavelength channel(s) requested are compared to those available and those wavelength channel(s) that are unavailable are indicated within the message. The configuration data signal is then regenerated and transmitted along its path further.

Once the configuration data signal has reached a destination thereof, the destination node selects a best wavelength channel(s) on which to receive the data signal and transmits its determination within a return configuration data signal back toward the first node. When the return configuration signal is received at each switching element, the switching element updates its configuration data accordingly to ensure proper configuration for directing the signal at the determined time and within the determined wavelength channel(s) to the destination node. When the return configuration signal reaches the first node, the first node schedules the data transmission accordingly. Of course, if the determined wavelength channel(s) is already being used at one of the intermediary switching elements, then another configuration signal is needed.

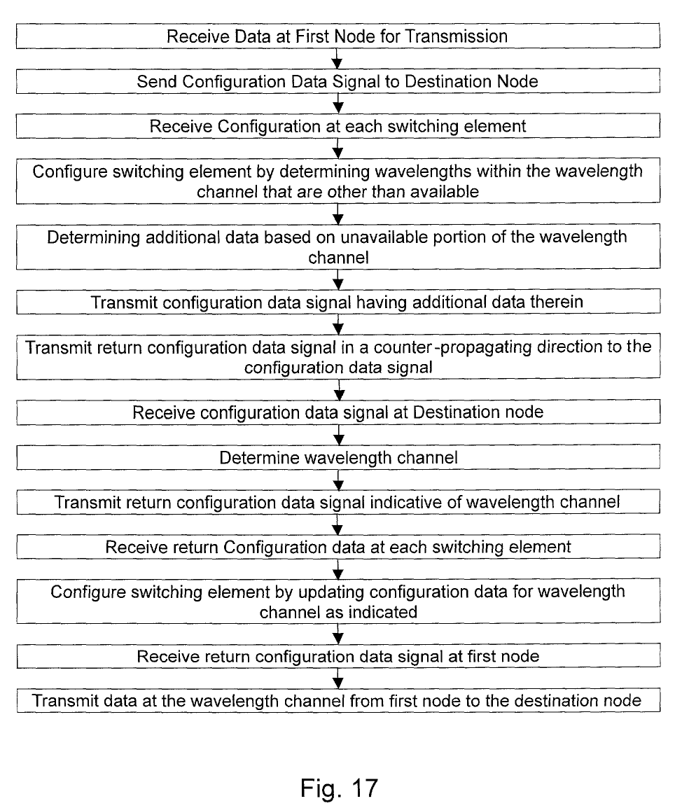

Referring to FIG. 17, a simplified flow diagram of a method according to the invention is shown for use with the timing diagram of FIG. 9. In a first step, a first node receives data to transmit to a second other node. A configuration data signal is transmitted from the node to the second other node indicating, for example, an amount of data to be transmitted, a preferred optical path if any, a timeslot in which to transmit the data, and one or more preferred wavelength channels in which to transmit the data.

The configuration signal is received by each all-optical switch along the data communication path. At each switch, the signal is received and analysed. The wavelength channel(s) requested is analysed and those wavelength channel(s) that are unavailable are indicated within the message. The configuration data signal is then regenerated and transmitted along its path further toward the second node and back toward the first node. This allows switching elements that have already been informed of potential use of wavelength channel(s) to update their wavelength channel database according to other switching element availability. Also, the first node is capable of updating its available transmit wavelength channel(s) based on freeing up unavailable wavelength channel(s).

Once the configuration data signal has reached a destination thereof, the destination node selects a best wavelength channel(s) to receive the data signal and transmits its determination within a return configuration data signal back toward the first node. When the return configuration signal is received at each switching element, the switching element updates its configuration data accordingly to ensure proper configuration for directing the signal at the determined time and within the determined wavelength channel(s) to the destination node. When the return configuration signal reaches the first node, the first node schedules the data transmission accordingly. Of course, if the determined wavelength channel(s) is already being used at one of the intermediary switching elements, then another configuration signal is needed. In this way an optical network supporting dynamic optical bust data propagation is configured very rapidly. Since the network is optically transparent, the optical signal may be transmitted at very high bit rates without requiring very expensive OEO conversion needed to support these very high bit rates in prior art networks. Additionally, the ability of the optical network according the invention allows it to be used very efficiently at very high data rates.

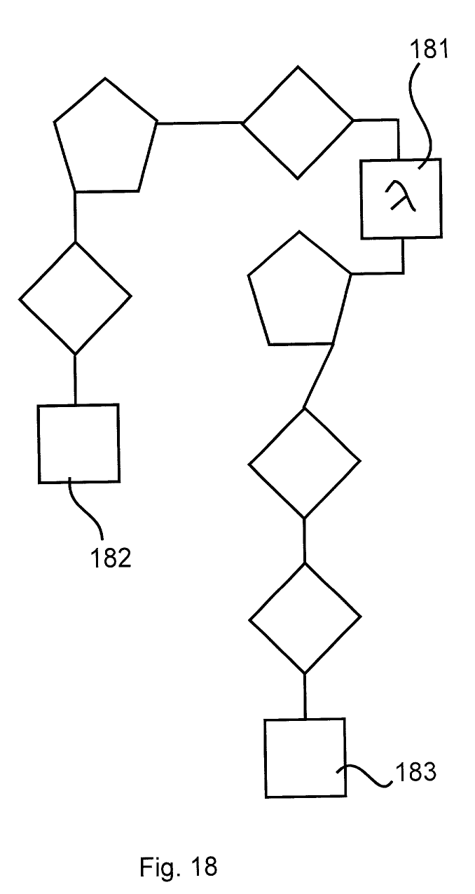

Referring to FIG. 18, a network architecture is shown in block diagram for a single communication path. Here, a plurality of switching elements is disposed between a first node and a second node. One of the intermediate switching elements 181 is provided with a wavelength conversion component. Thus, from node 182 to wavelength converter 181 is formed a first optical path at a first fixed wavelength. Form wavelength converter 181 to a second node 183 is a second optical path at a same or other fixed wavelength. Thus, though the optical path must be set-up and exist for a single transmission time from the first to the second other node. The wavelength of that signal can be converted partway through the transmission path.

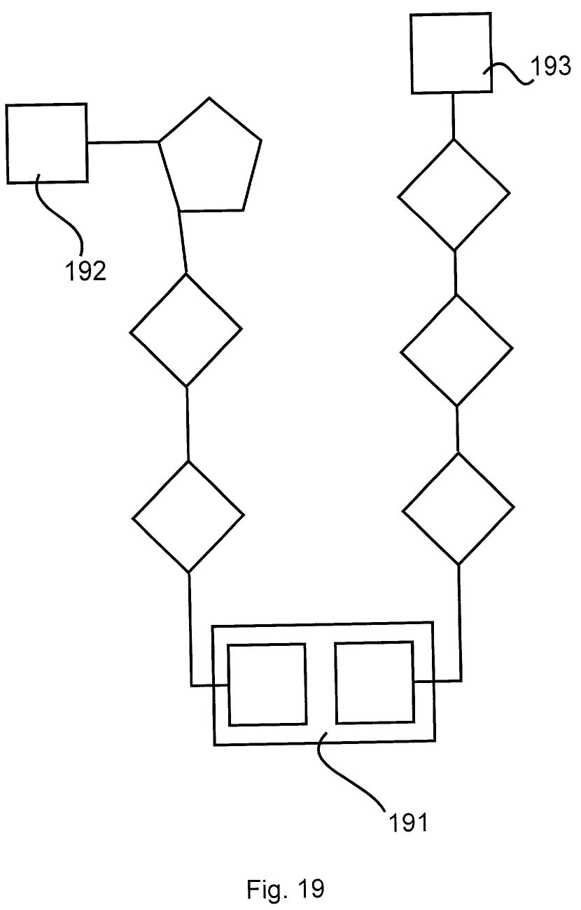

Referring to FIG. 19, a network architecture is shown in block diagram for a single communication path. Here, a plurality of switching elements is disposed between a first node and a second node in the form of an opto-electro-opto conversion component 191. One of the switching elements is provided with the opto-electro-opto conversion component. Thus, from node 192 to opto-electro-opto conversion component 191 is formed a first optical path at a first fixed wavelength. From opto-electro-opto conversion component 191 to a second node 193 is a second optical path at a same or other fixed wavelength. Thus, though the optical path must be set-up and exist for a single transmission time from the first to the second other node. The wavelength of that signal can be converted partway through the transmission path.

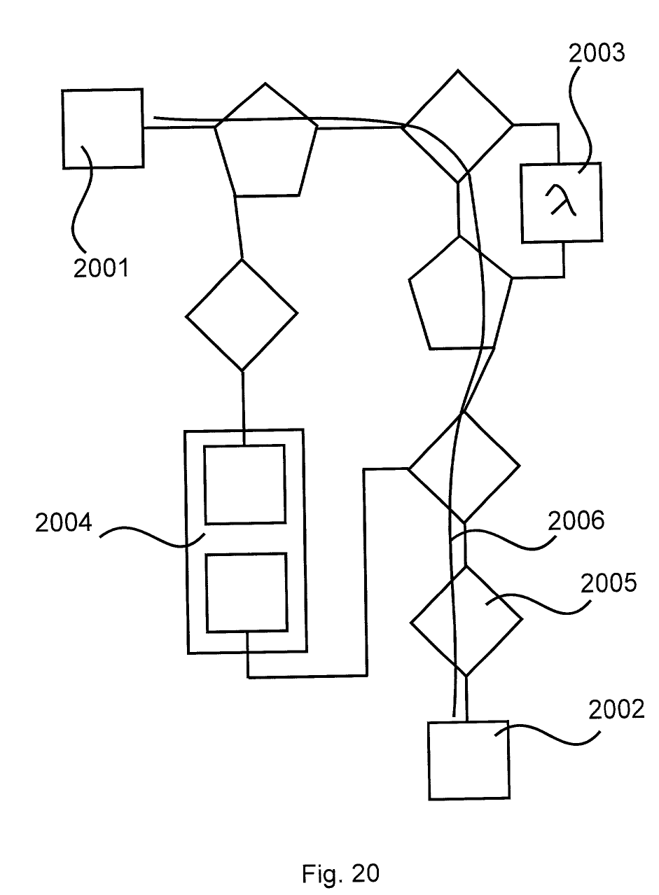

Referring to FIG. 20 a network topology is shown for use with a signal routing method according to the invention. This topology includes a path 2006 permitting direct optical communication absent wavelength conversion or optical buffering between a first node 2001 and a second node 2002. During times of very high network data traffic this path is less likely to be available. For example, when data traffic is unusually high at node 2005 it will become more difficult to establish an optical connection between two nodes. To improve the ease of establishing the desired optical connection an alternative optical path featuring a wavelength converter 2003 is provided. Thus, those optical wavelength channels that are in high demand from other sources and receivers (not shown) are avoided in setting up the optical connection at or about the high traffic node 2005 by converting the wavelength of the signal transmitted from the first node to another wavelength for which a timeslot at node 2005 is available. Alternatively, OEO 2004 is used to perform the wavelength conversion process.

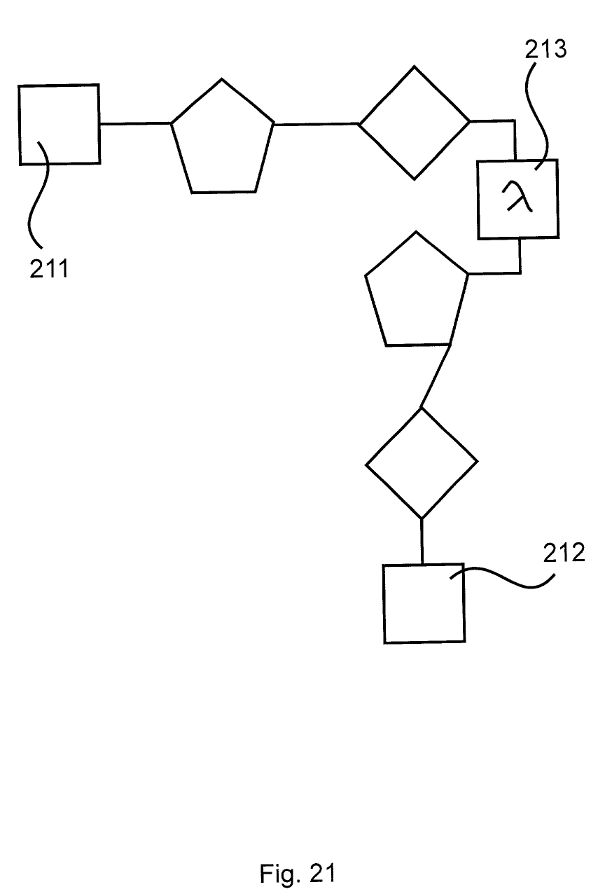

Referring to FIG. 21, a network topology is shown in which a first low data traffic section of the network supports only 4 wavelength channels and a second high data traffic section supports 80 wavelength channels. The node 211 provides an optical signal within one of the 4 wavelength channels that propagates to the wavelength converter 213. The optical signal is converted to a signal within an available wavelength channel to propagate within the second section of the network and is received by the second node 212. Using this technique, it possible to facilitate connection of a relatively low traffic network to high traffic network.

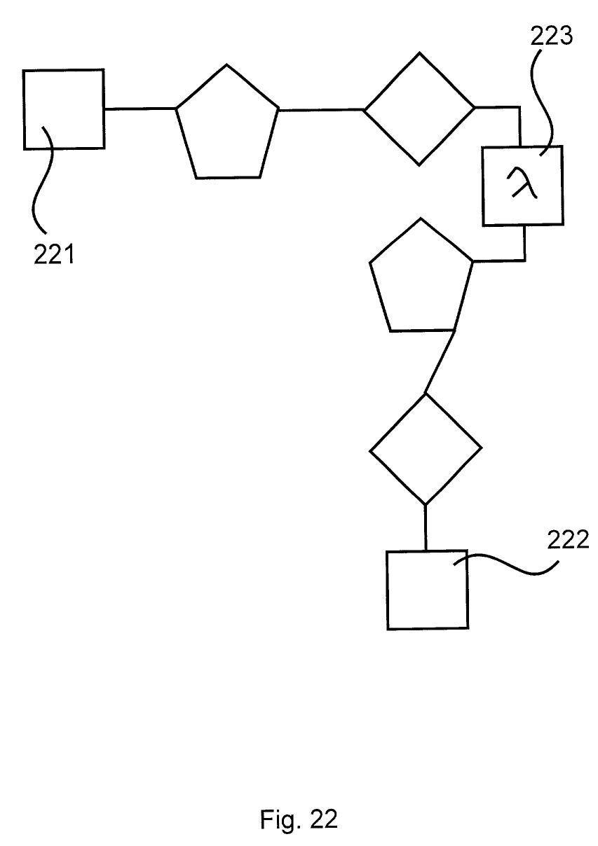

Referring to FIG. 22, a network topology is shown in which a first high data traffic section of the network supports 80 wavelength channels and a second lower data traffic section supports only 4 wavelength channels. The node 221 provides an optical signal within one of the 80 wavelength channels that propagates to the wavelength converter 223. The optical signal is converted to a signal within an available wavelength channel for propagating within the second section and is received by the second node 222. Using this technique, it possible to facilitate connection of a relatively low traffic network to high traffic network.

Alternatively, the methods of network configuration for determining a timeslot and for determining a wavelength channel are used one in conjunction with another to increase the variables in network configuration thereby supporting more diverse network routing and, likely, more successful routing in response to first configuration signals. In such an embodiment, timeslots and wavelength channels are both proposed by a source node and one or more of the timeslot-wavelength channel pairings is selected for use in the data transmission.

Alternatively, when a wavelength conversion component is disposed within the optical path, the wavelength conversion component proposes further timeslot/wavelength channel pairings for downstream from the wavelength conversion component. This provides for support of any number of wavelengths without the querying node having complete network topology data stored therein.

Of course, the present invention is functionally advantageous over the prior art with or without wavelength conversion or optical signal buffering. For example, when large numbers of switches are interconnected, some wavelength conversion will greatly enhance network routing functions without detracting from the advantages of the present invention. This is evident to those of skill in the art since it effectively changes the routing problem into two interdependent routing problems each with fewer switching elements. Buffering within some switching elements will act to reduce the interdependency and simplify the routing problem further.

Of course, since network topologies are large and complex, some destination nodes are only separated from the first node by one switching element while others are separated by many switching elements and, as such, freeing up of transmission timeslots.

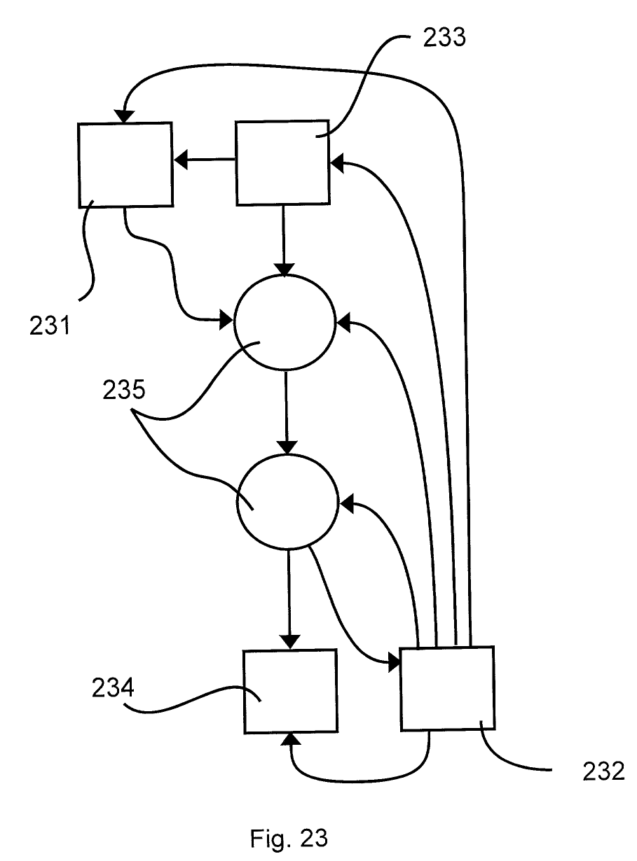

Referring to FIG. 23, another embodiment of the invention is shown. This embodiment features a dedicated query node 231 and a dedicated decision node 232. Of course, it is possible to have only one of the query and decision nodes be a dedicated node or that a same node perform both functions. The network also includes: a transmitter node 233, a receiver node 234 and two switching elements 235. In operation, the transmitter node 233 establishes is provided with data intended for the receiver node 234. The transmitter node informs the query node 231 and the query node 231 transmits a query signal including a plurality of proposed timeslot-wavelength channel pairings to the switching elements 235 of the network disposed between the transmitter node 231 and the receiver node 234. The query signal is received by each switching element 235 and modified thereby to include data associated with availability of the switching element at various future timeslots and within supported wavelength channels. The modified query signal is received by the decision node 232. The decision node 232 determines from the modified query signal data a communication path, timeslot and wavelength for the proposed optical signal being sent from the transmitter node to the receiver node. Once this decision is made, the decision node transmits a signal to the receiver node, the transmitter node and the switching elements therebetween along the determined optical path. The transmitter node then schedules the transmission of the data signal as determined at the determined timeslot. The switching elements having received the information from the decision node will be properly set to provide an optically continuous path from the transmitter node to the receiver node. The receiver node having been informed that the optical signal will be arriving within a predetermined timeslot and wavelength channel is properly configured to receive it. The network described in FIG. 23 shows a very small number of components to ensure that the figure is clear. Other optical networks based upon this design would feature much larger numbers of transmitters, receivers and switching elements.

Ideally, the process routing data will always result in the receiver receiving the optical signal from the transmitter. In the event of a lack of network path availability, the transmitter node retransmits the message to the query node and the process of configuring the network is repeated.

Alternatively, the transmitter node, the first node, is also the node making the timeslot/wavelength channel pairing decision. Further alternatively, each switching element and node executes a same decision process. In such a method, each node and element is provided with same data such that same routing decision relating to timeslot/wavelength channel pairing is made at each node thereby eliminating a need for transmitting a control signal to each switching element.

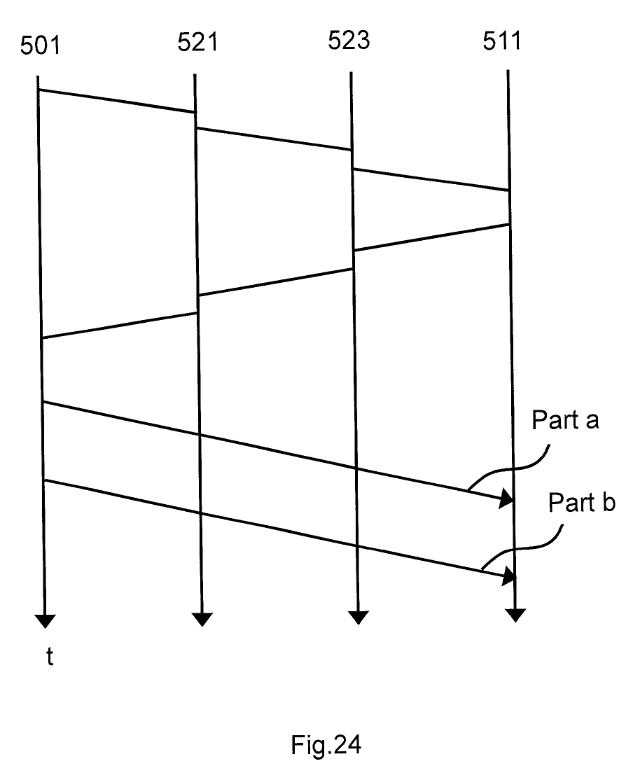

Referring to FIG. 24, a simplified timing diagram is shown wherein an optical data signal is transmitted within two timeslots at a same or different wavelength channels. Here, a query signal is transmitted from a transmit node and data associated with availability of intermediate switching elements is determined. The data and the query are provided to a second node. The second node determines a non-contiguous timeslot—a timeslot having two separate timeslots—for supporting the optical data transmission. Similarly, optical data signals can be transmitted within two wavelength channels simultaneously or separately. Of course further timeslots optionally form part of a non-contiguous timeslot/wavelength channel pairing.

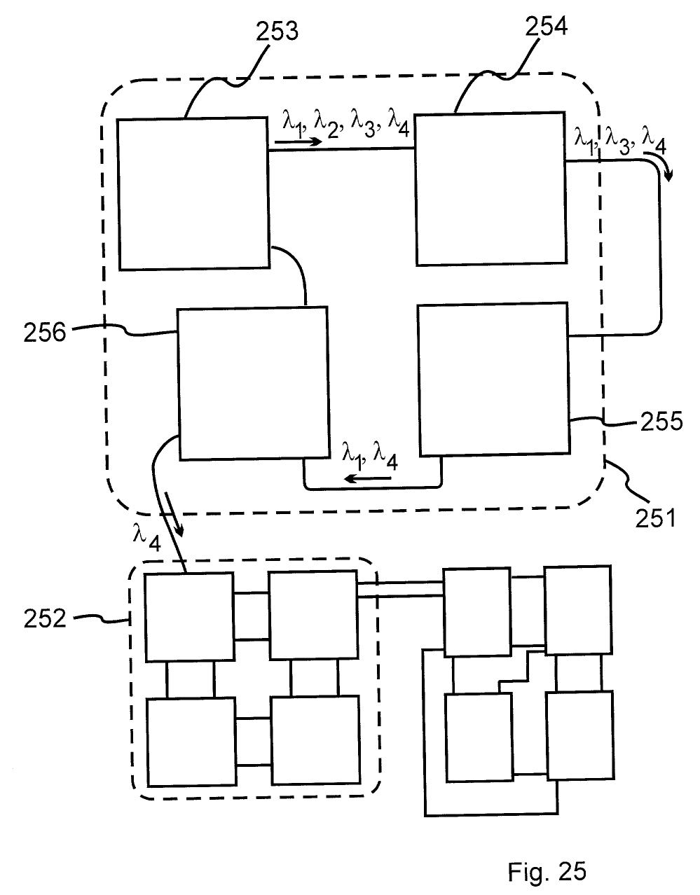

Referring to FIG. 25, a network comprising three sub-networks according to an embodiment of the invention is shown. Though switching within each network appears a simple task, inter-network switching is quite complex because of the vast number of potential destinations. A signal from the sub-network 251 being sent to the sub-network 252 requires an available wavelength channel at an available time with an availableoptical path. Without using wavelength conversion or opto-electronic conversion, a plurality of same data signals is transmitted within several different wavelength channels simultaneously. Thus, the data leaves node 253 encoded within signals at wavelengths 1, 2, 3, and 4. At node 254 a signal at wavelength 2 is blocked—attenuated—because it conflicts with existing optical data signals. At node 255, a signal at wavelength 3 is blocked—attenuated—because it conflicts with existing optical data signals. At node 256, a signal at wavelength 1 is blocked due to conflicts with existing propagating optical signals. The signal at wavelength 4 propagates in an undisturbed manner from sub-network 251 to sub-network 252 along the predetermined route. Of course, the switching fabric may dynamically assign the route thereby providing enhanced flexibility.

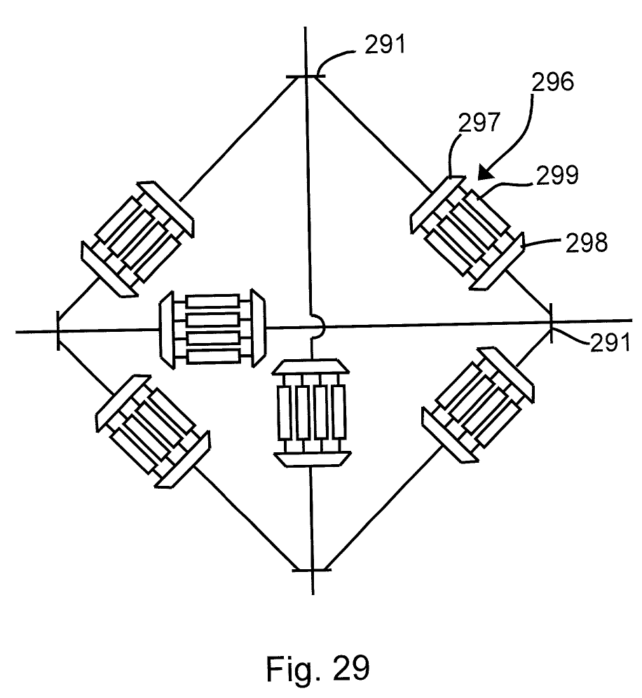

Referring to FIG. 29, a simplified block diagram of a switch for use with a routing process according to the invention is shown. Here a single switch is shown though a plurality of switches typically is combined in a known fashion to form a network. The optical wavelength switch shown is a bidirectional 4×4 switch. This switch receives optical signals at each of four input ports. Each of the four input ports is coupled to a star coupler 291 dividing a signal propagating into the input port into N-1 or 3, optical paths. Each of the three signals is then provided to a channel selective amplifier attenuator 296 for attenuating and/or amplifying each individual signal independently. The signals are provided in a multiplexed fashion from the channel selective amplifier attenuator to a star coupler of another port. Thus, the input ports of the switch also provide the output optical signals from the switch. This configuration is unlike a conventional 4×4 optical switch that has four dedicated input ports for receiving optical signals and four dedicated output optical paths for providing optical signals.

The channel selective device 296 comprises a demultiplexer 297 for separating the optical signal into signals within each of a plurality of wavelength channels. The separated signals each propagate along an independent path through a channel selector299. The channel selector299 acts to selectively pass a signal or substantially attenuate same. Thus in conjunction, the channel selectors 299 act to selectively pass signals within wavelength channels independently and, optionally, to amplify some of those signals. Alternatively, each channel selector 299 is only for attenuating optical signals within a single independent path. For example, when the channel selector 299 comprises a shutter, optical signals within each of the N independent paths, one for each wavelength channel, are selectably blocked. Alternatively, the channel selector 299 comprises on optical amplifier that selectively increases the intensity of optical signals. In this case, the switch relies on attenuation of the optical path to reduce those signals that are other than amplified below the noise floor of the system to prevent further unintended amplification. Additionally, an amplifier capable of optionally attenuating optical signals will attenuate optical signals that are other than amplified to ensure that they are below the noise floor of the system. The channel selective device 296 also includes a multiplexer 298 for recombining signals within wavelength channels that are other than blocked to form a single multiplexed signal. Of course, other forms of the channel selectors are usable with the present invention in so far as they support the functionality required therefore. The channel selective element 306 is fully bi-directional.

This allows a data signal to be transmitted from a first port to a second other port without OEO conversion thereof reducing potential errors introduced within signals during processing or conversion such as those associated with optical signals having data rates in excess of electrical hardware supported speeds. It also maintains substantial flexibility in the switching fabric to support large bandwidth and greatly reduces the complexity and cost of the switching fabric itself. Also, all light generation occurs outside the switching fabric, which is highly advantageous.

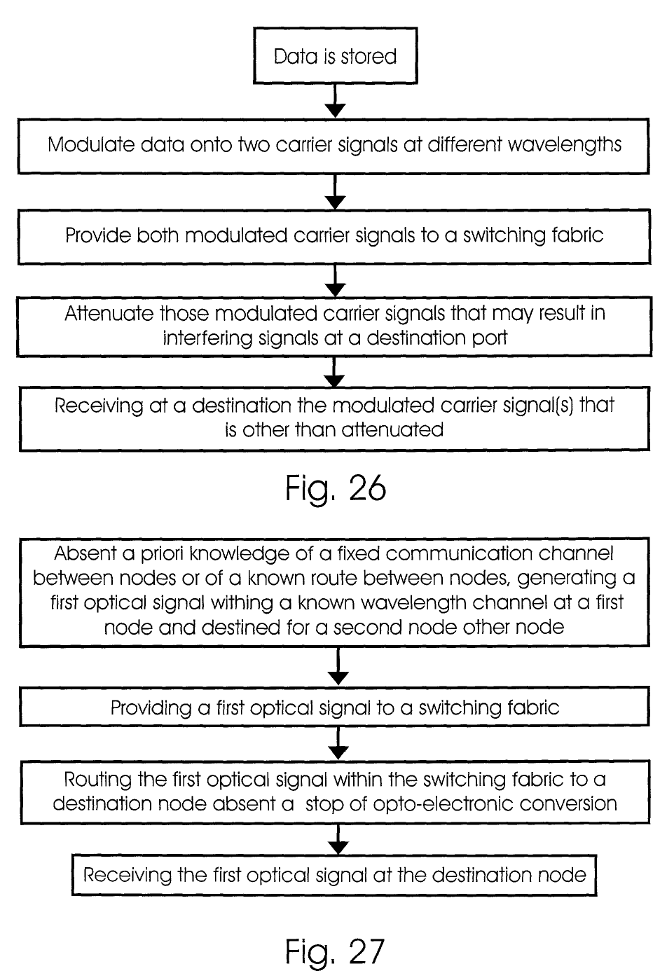

Referring to FIG. 26, a simplified flow diagram is shown. Data is stored within a data memory for transmission from node A to node B within a communication network. The communication network includes an optical communication switch. The communication switch incorporates a switching fabric that does not provide for buffering of optical data therein or for converting optical signals between different carrier wavelengths.

The data is provided to an optical signal modulator. There, multiple carrier signals are modulated with the data each within different wavelength channels and each generated by a light source, such as a laser diode. The optical data signals are then provided to the optical switching fabric. Within the optical switching fabric, the optical data signals are routed from a source port to a destination port. Those signals that are likely to interfere with other signals at the destination port of the switching fabric are attenuated. When at least one of the optical data signals are non-interfering with signals at the destination port, the data is successfully transmitted between the source node and the destination node.

Routing of the optical data signal is performed by one of passing or attenuating the signal in an optical communication path between the source node and the destination node. Within the switch, no buffering and/or opto-electric conversion of the signal is provided so the signal traverses the switching fabric at high speed with little delay. Of course, when no available wavelength channels are available within any of the paths, all of the data signals are attenuated and the signal must be retransmitted from its source. As such, the only limitations on switching speed are the switching fabric setup time and route availability.

In a preferred embodiment, switching fabric setup time is reduced by the steps of providing the optical data signal in each of several optical paths and performing within each path independently one of blocking the optical signal and other than blocking the optical signal. Using an attenuator having a fast setup time allows for faster switching times and faster switch setup times.

Referring to FIG. 27, another flow diagram of a method according to the invention is shown. Here, absent a priori knowledge of a fixed communication channel between a source and destination node or of a known route between the nodes, a communication process is undertaken. A first optical signal is generated within a known wavelength channel at a first node and having data modulated therein. The signal propagates to a second other node.

The first optical signal is routed within the switching fabric to a destination node absent a step of opto-electronic conversion and is then received at the destination node. When routing of the first optical signal results in a potential collision between optical signals, the switching fabric attenuates the optical signal prior to the collision occurring. Preferably, when an optical signal is blocked or attenuated, the source is notified of this. This allows the source to retransmit the optical signal within a same or different wavelength channel.

By using high speed attenuators, the system provides for very fast switching fabric setup times allowing for transmission and retransmission in times shorter than current optical communication systems require to be set up. Current optical switches require more than one millisecond to setup for routing between nodes.

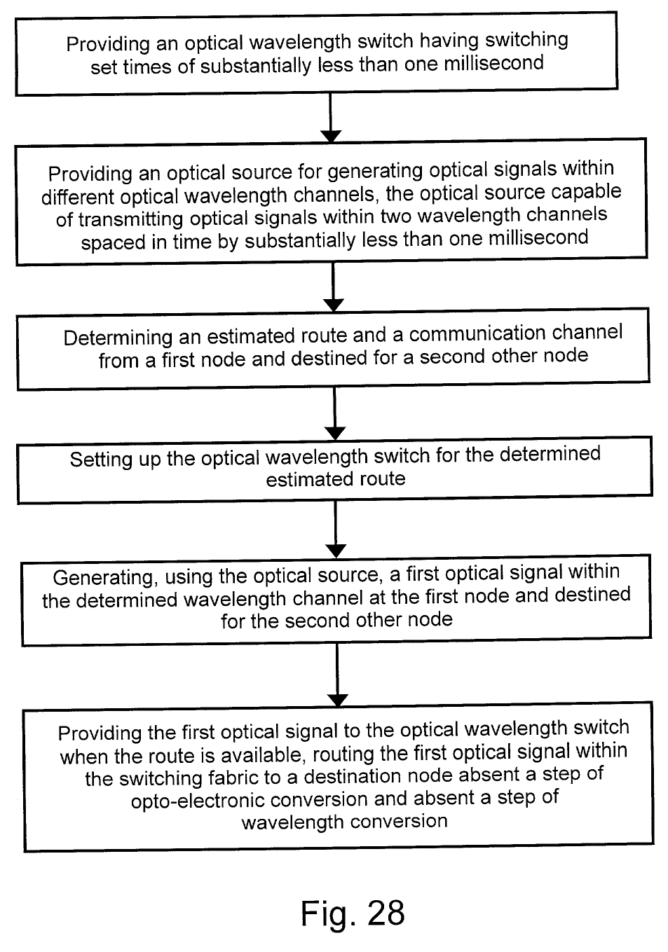

This leads us to another aspect of the present invention as shown in the simplified flow diagram of FIG. 28. An optical wavelength switch having switching setup times of substantially less than one millisecond is provided. Also, an optical source for generating optical signals within different optical wavelength channels, the optical source capable of transmitting optical signals within two different wavelength channels spaced in time by substantially less than one millisecond is provided. The source and switch are used to setup signal paths rapidly in order to enable very high speed optical signal switching. A route and a communication channel from a first node and destined for a second other node are determined using a predetermined process. The process may employ a determination system that results in an estimate in place of a fixed known available route. Because of the flexibility of the switch, it is possible to use a route whose allocation is uncertain and, when unavailable, the optical data signal can be retransmitted without substantial delay due to the fast set up time of the optical switching fabric and of the optical source. Once the route is determined, the optical wavelength switch is set up for the determined estimated route. Then, using the optical source, a first optical signal is generated within the determined wavelength channel at the first node and destined for the second other node. The first optical signal is provided to the optical wavelength switch and subsequently when the route is available the first optical signal is routed within the switching fabric to the second other node absent a step of opto-electronic conversion and absent a step of wavelength conversion. Of course when the route is actually unavailable, the signal is blocked or attenuated and the source is provided with an indication of this. This allows the source to transmit on another wavelength immediately to allow for successful routing of the data signal within a same or shorter time frame than is supported by current dynamic optical signal routing systems.

Alternatively, in the above-described embodiment, more than one data signal having same data modulated therein and encoded within carrier signals at different wavelengths are sent simultaneously from the first node to the second node. When at least one signal is successfully routed to the second node, the transmission is successful; otherwise, retransmission of the data is required.

In accordance with another embodiment, a first signal transmitted from a first node to a second node establishes a route. Thus, when the signal reaches the second node, the routing is maintained within the switch allowing further communication between the nodes. Optionally, the nodes can signal the switch to free up a route once it is no longer required. In such a case, the second node typically informs the first node of the wavelength channel of the optical signal that is received so that at the first node only a signal within that wavelength channel is generated. Alternatively, two or more routes are maintained to support data transmission redundancy within the network.

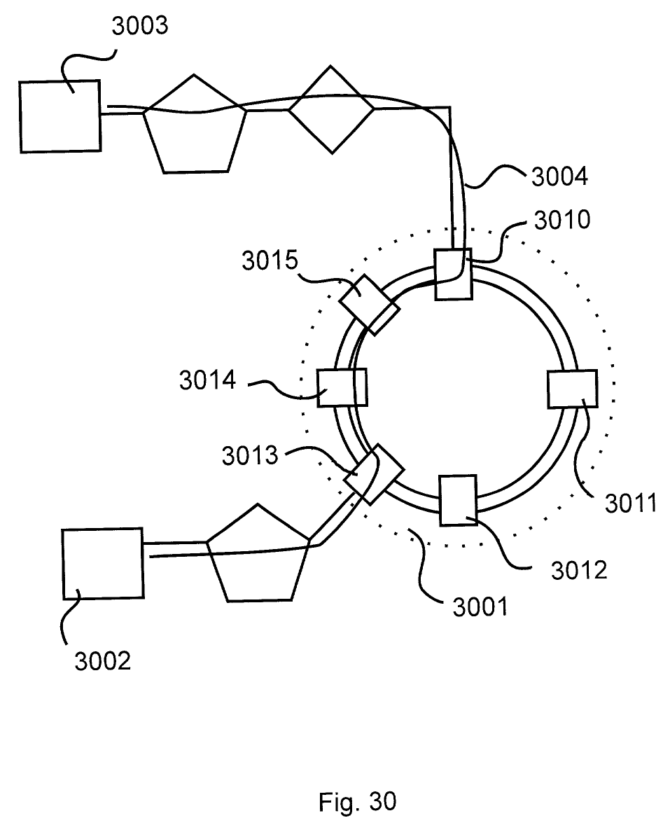

Referring to FIG. 30, a hybrid optical network according to the invention is shown in which an existing SONET network 3001 is optically coupled within a path of a network according to the invention. A transmitter 3002 provides an optical query signal to the network in order to send data to a receiver 3003. The SONET network 3001 provides data associated with supported wavelength channel and timeslot availability. An optical communications path 3004 is chosen. The SONET network 3001 continues to operate normally. The six nodes 3010 to 3015 of the SONET network continue to operate without interference. In this way, the existing SONET Network 3001 supporting fixed timeslot allocation is used as an intermediate node within the network according to the invention. It should be noted that the characteristics for the differing optical components at each node would determine the availability of timeslots, wavelengths and timeslot/wavelength channel pairings. In this case, the ability to configure the network along a given path is subject to the time required for the configuration of the slowest component along that path. Further, by introducing components with differing latency, a complexity of establishing a timeslot/wavelength channel pairing increases, but the process continues to function. Optionally, specific wavelength channels supported by the SONET network 3001 are dedicated to servicing the network according the invention. This enhances the isolation of the data signals used by the network according to the invention from the data signals used by the SONET network.

Though some of the above embodiments refer to transmitting same data modulated within optical carrier signals at different wavelengths in a parallel fashion, it is equally possible to do so in a sequential fashion on a same carrier wavelength signal or on optical carrier signals at different wavelengths. In such an embodiment, a number of signals, N, each with same data optically modulated therein are transmitted one after the other. This provides similar advantages to the parallel transmission embodiment without actually transmitting same data at same time.

Though in the above description, nodes are described as selecting a path, this need not be the case. Optionally, a busiest switching element within the network makes the decision.

Optionally, more than one timeslot/wavelength channel pairing are selected to provide for redundancy in network data transmissions.

Of course, the above invention is also useful with existing network architectures by filling in unused bandwidth that is known to be unused. This allows for piggybacking on existing installed fibre.

In an embodiment, the proposed timeslot extends for a substantial length of time allowing for an approximate guarantee that a timeslot within the proposed timeslots is available. For example, a decision optionally includes two timeslot/wavelength channel pairings to allow for a first more risky timeslot for data transmission and a second more conservative and approximately guaranteed timeslot/wavelength channel pairing. Thus, if the data is received at the second node, the second transmission is optionally prevented reducing network traffic.

Numerous other embodiments may be envisaged without departing from the spirit or scope of the invention.

What is claimed is:

1. A method of allocating resources within an optical network comprising the steps of:
providing a request for an optical path from a first node for transmission to a second other node;
providing a first query signal proposing at least a timeslot/wavelength channel pairing for an optical path corresponding to the request for an optical path;
receiving the query signal and data relating to availability of switching elements disposed within the optical path between the first node and the second other node;
selecting one of the proposed timeslot/wavelength channel pairings for the data transmission; and,
providing a command signal to each switching element requiring configuration to allow said elements to be configured for the selected timeslot/wavelength channel pairing to support communication from the first node to the second node of the provided data.

2. A method of allocating resources according to claim 1 wherein the command signal is provided to nodes and elements other than the element performing the step of selecting.

3. A method of allocating resources according to claim 1 wherein the included data includes data relating to switching element setup times to ensure that switching elements are available within a selected timeslot.

4. A method of allocating resources according to claim 1 wherein the timeslot is larger than the timeslot necessary to transmit the data in order to accommodate timing synchronization errors within the network.

5. A method of allocating resources according to claim 1 wherein the first query signal is transmitted from the first node.

6. A method of allocating resources according to claim 1 wherein the step of selecting is performed by the second other node.

7. A method of allocating resources according to claim 6 wherein the first query signal is transmitted from the first node.

8. A method of allocating resources according to claim 1 wherein the step of selecting is performed by the first node.

9. A method of allocating resources according to claim 7 wherein the command signal is provided via a return path from the second other node to the first node.

10. A method of allocating resources according to claim 1 wherein some of the switching elements are absent wavelength conversion capabilities.

11. A method of allocating resources according to claim 10 wherein the switching elements are absent buffering capabilities for buffering optical data.

12. A method of allocating resources according to claim 10 wherein the timeslot/wavelength channel pairing comprises a same wavelength channel for supporting the communication along an entire optical communication path from the first node to the second other node.

13. A method of allocating resources according to claim 12 wherein the second node receives a plurality of signals each including data relating to timeslot/wavelength channel pairing availability for a same optical path.

14. A method of allocating resources according to claim 13 wherein the included data includes data relating to switching element setup times to ensure that switching elements are available within a selected timeslot.

15. A method of allocating resources according to claim 12 wherein the timeslots are each shifted one relative to the other in dependence upon a known latency between switching elements.

16. A method of allocating resources according to claim 15 wherein the timeslot is larger than the timeslot necessary to transmit the data in order to accommodate timing synchronization errors within the network.

17. A method of allocating resources according to claim 16 wherein the timeslot is a non-contiguous timeslot.

18. A method of allocating resources according to claim 16 wherein the switching elements provide additional statistical data relating to timeslot availability.

19. A method of allocating resources according to claim 18 wherein the step of selecting is performed absent a guarantee of timeslot/wavelength channel availability.

20. A method of allocating resources according to claim 1 wherein the step of selecting is performed absent a guarantee of timeslot/wavelength channel availability.

21. A method of allocating resources according to claim 1 wherein a switching element comprises a wavelength conversion component and wherein said switching element provides proposed timeslot/wavelength channel pairings for optical data communication downstream of said switching element.

22. A method of allocating resources according to claim 21 wherein the timeslot/wavelength channel pairing comprises two different wavelength channels one before a wavelength converter and another after the wavelength converter along the optical communication path.

23. A method of allocating resources according to claim 1 wherein a proposed timeslot/wavelength channel pairing extends sufficiently far into the future to approximately guarantee timeslot availability.

24. A method of allocating resources according to claim 1 wherein two timeslot wavelength channel pairings are selected for transmission of same data within each thereof.

25. A method of allocating resources according to claim 1 wherein two timeslot wavelength channel pairings are selected for transmission of a portion of the data within each thereof.

26. A method of allocating resources according to claim 1 wherein the timeslots are each shifted one relative to the other in dependence upon a known latency between switching elements.

27. A method of allocating resources according to claim 26 wherein the timeslot is larger than the timeslot necessary to transmit the data in order to accommodate timing synchronization errors within the network.

28. A method of allocating resources according to claim 26 wherein the timeslot/wavelength channel pairing comprises two different wavelength channels one before a wavelength converter and another after the wavelength converter along the optical path.

29. A method of allocating resources according to claim 28 wherein a timeslot is larger than the timeslot necessary to transmit the data in order to accommodate timing synchronization errors within the network.

30. A method of allocating resources according to claim 1 wherein the selection is performed absent a guarantee of timeslot/wavelength channel availability.

31. A method of allocating resources according to claim 1 wherein the timeslot/wavelength channel pairing comprises a same wavelength channel for supporting the communication along an entire optical communication path from the first node to the second other node.

32. A method of allocating resources according to claim 31 wherein selected timeslot/wavelength channel pairing includes path information for establishing a communication path within the timeslot/wavelength channel pairing along an optical path relating to the path information.

33. A method of allocating resources according to claim 1 comprising the steps of:
at each switching element receiving the query signal and determining data relating to the proposed timeslot/wavelength channel pairing;
including within the query signal the determined data; and,
transmitting the query signal including the determined data.

34. A method of allocating resources according to claim 1 comprising the steps of:
at each switching element receiving the signal and determining data relating to the selected timeslot/wavelength channel pairing; and,
transmitting a counter propagating signal along a path in a direction counter propagating to the signal and indicative of the determined data.

35. A method of allocating resources according to claim 1 wherein the query signal is provided along a plurality of optical data paths between the first node and the second node, and wherein the step of selection includes selecting a path of the plurality of paths.

36. A method of allocating resources according to claim 1 wherein the data for performing the step of selection is weighted based on a general availability of each switching element within the optical path.

37. A method of allocating resources according to claim 36 wherein the busiest element within the optical path is the element that performs the step of selecting.

38. A method of allocating resources according to claim 1 wherein data for performing the step of selection is provided from only a subset of the switching elements between the first node and the second node along the optical path.

39. A method of allocating resources within an optical network comprising the steps of:
providing a request for an optical path from a first node for transmission to a second other node;
providing a first query signal to the second other node;
at the second other node, selecting a timeslot/wavelength channel pairing for an optical path according to the request for an optical path absent predetermined knowledge that the timeslot/wavelength channel pairings is available for the transmission; and,
providing a command signal to each element requiring configuration to allow said elements to be configured for the selected timeslot/wavelength channel pairingalong an optical path according to the request for an optical path.

40. A method of allocating resources according to claim 39 wherein the command signal is provided to nodes and elements other than the element performing the step of selecting.

41. A method of allocating resources according to claim 39 wherein the first query signal is transmitted from the first node.

42. A method of allocating resources according to claim 41 wherein the command signal to each element is provided via a return path from the second other node to the first node.

43. A method of allocating resources according to claim 39 wherein some of the switching elements are absent wavelength conversion capabilities.

44. A method of allocating resources according to claim 43 wherein the switching elements are absent buffering capabilities for buffering optical data.

45. A method of allocating resources according to claim 43 wherein the timeslot/wavelength channel pairing comprises a same wavelength channel for supporting the communication along the entire length of the optical path from the first node to the second other node.

46. A method of allocating resources according to claim 45 wherein the second node receives a plurality of signals each including data relating to timeslot/wavelength channel pairing availability for an at least an optical path.

47. A method of allocating resources according to claim 45 wherein the timeslots are each shifted one relative to the other in dependence upon a known latency between switching elements.

48. A method of allocating resources within an optical network comprising the steps of:
absent a priori knowledge of a fixed communication timeslot/wavelength channel pairing between nodes or of a known available optical path between nodes, generating a first optical signal within a known timeslot/wavelength channel pairing at a first node and destined for a second other node;
providing the first optical signal to a switching fabric;
propagating the first optical signal within the switching fabric to the second other node; and,
receiving the first optical signal at the second other node.

49. A method of allocating resources within an optical network according to claim 48 wherein the step of propagating is performed absent a step of opto-electronic conversion.

50. A method according to claim 48 wherein the step of propagating the first optical signal comprises the step of:
providing the first optical signal along each of several optical communication paths within at least a timeslot/wavelength channel pairing.

51. A method according to claim 50 wherein the step of propagating the first optical signal comprises the step of:
performing within each path independently one of blocking the first optical signal and other than blocking the optical signal.

52. A method according to claim 48 including the steps of:
generating a second optical signal within a known timeslot/wavelength channel pairing at the first node and destined for the second other node;
providing the second optical signal to the switching fabric wherein the steps of providing the first optical signal and providing the second optical signal are performed in sequence, such that the first and second signals are provided to the switching fabric within different timeslots.

53. A method according to claim 52 wherein the first and second optical signals are each within a same wavelength channel.

54. A method according to claim 52 wherein the first and second optical signals are each within a different wavelength channel.

55. A method according to claim 48 wherein the light source is one of a plurality of light sources each dedicated to generating light within a different known optical wavelength channel.

56. A method according to claim 55 wherein the first optical signal is blocked within the switching fabric when an optical path to the second other node within the known timeslot/wavelength channel pairing is unavailable.

57. A method according to claim 56 comprising the step of:
upon blocking of the first signal within the switching fabric, transmitting a message to the first node indicative of the first signal being blocked.

58. A method according to claim 57 comprising the steps of:
generating a second optical signal within a different timeslot/wavelength channel pairing at the first node and destined for the second other node and having the same data modulated therein in response to the message; and,
providing the second optical signal to a switching fabric in response to the message.

59. A method according to claim 48 comprising the steps of:
generating a second optical signal within a second other timeslot/wavelength channel pairing and including same data as the first optical signal; and,
providing the second optical signal to the switching fabric.

60. A method according to claim 59 wherein the first and second optical signals are provided to the switching fabric approximately simultaneously and wherein the step of propagating the first optical signal comprises the steps of:
providing the first optical signal in each of several optical paths within at least a timeslot/wavelength channel pairing; and,
performing within each path independently one of blocking the first optical signal and other than blocking the optical signal.

61. A method according to claim 59 wherein the step of performing one of blocking and other than blocking is performed in dependence upon availability data, the availability data indicative of a timeslot/wavelength channel pairing from the first node to the second node.

62. A method of allocating resources within an optical network comprising the steps of:
providing an optical wavelength switch having switching setup times of substantially less than one millisecond;
providing an optical source for generating optical signals within any of a plurality of different optical wavelength channels, the optical source capable of transmitting optical signals within two different wavelength channels spaced in time by substantially less than one millesecond;
determining a proposed timeslot/wavelength channel pairing from a first node and destined for a second other node, the proposed timeslot/wavelength channel pairing other than a known available timeslot/wavelength channel pairing;
setting up the optical wavelength switch for the determined proposed timeslot/wavelength channel pairing;
generating, using the optical source, a first optical signal within the determined timeslot/wavelength channel pairing at the first node and destined for the second other node;
providing the first optical signal to the optical wavelength switch; and,
when the timeslot/wavelength channel pairing is available propagating the first optical signal within the switching fabric to the second other node.

63. A method according to claim 62 wherein the step of propagating the first optical signal is performed absent a step of opto-electronic conversion and absent a step of wavelength conversion.

64. A method according to claim 62 wherein the step of propagating the first optical signal comprises the steps of:
providing the first optical signal in each of several optical paths within the timeslot/wavelength channel pairing; and,
performing within each path independently one of blocking the first optical signal and other than blocking the optical signal.

65. A method according to claim 62 wherein the first optical signal is generated by a light source dedicated to generating light within the known optical wavelength channel.

66. A method according to claim 65 wherein the light source is one of a plurality of light sources each dedicated to generating light within a different known optical wavelength channel.

67. A method according to claim 65 wherein the first optical signal is blocked within the switching fabric when the proposed timeslot/wavelength channel pairing to the destination node is unavailable.

68. A method according to claim 67 comprising the step of:
upon blocking of the first signal within the switching fabric, transmitting a message to the first node indicative of the first signal being blocked.

69. A method according to claim 68 comprising the step of:
generating a second optical signal within a second other timeslot/wavelength channel pairing at the first node and destined for the second other node and having the same data transmitted therein in response to the message; and,
providing the second optical signal to a switching fabric in response to the message.

70. A method according to claim 62 comprising the step of generating a second optical signal within a second other timeslot/wavelength channel pairing and including same data as the first optical signal; and,
providing the second optical signal to the switching fabric.

71. A method according to claim 70 wherein the light source includes a plurality of independent light sources each for generating light within a different wavelength channel.

72. A method of allocating resources within an optical network according to claim 71 wherein the first and second optical signals are provided to the switching fabric approximately simultaneously and wherein the step of propagating the first optical signal comprises the steps of:
providing the first optical signal in each of several optical paths within a same timeslot/wavelength channel pairing; and,
performing within each path independently one of blocking the first optical signal and other than blocking the optical signal.

73. A method of allocating resources within an optical network according to claim 70 wherein the step of performing one of blocking and other than blocking is performed in dependence upon availability data, the availability data indicative of a path and of a timeslot/wavelength channel pairing from the first node to the second node.

74. A method according to claim 62 comprising the steps of:
when an available timeslot/wavelength channel pairing is other than present, attenuating the first optical signal;
transmitting an indication that the first optical signal was attenuated;
generating another optical signal having same data and within a different timeslot/wavelength channel pairing for propagating within the switching fabric,
wherein from the step of generating the first optical signal to the end of the step of generating another optical signal requires less than one millisecond.

75. A method according to claim 62 comprising the steps of:
when an available timeslot/wavelength channel pairing is other than present, attenuating the first optical signal;
transmitting an indication that the first optical signal was attenuated;
generating another optical signal having same data within a different timeslot/wavelength channel pairing for propagating within the switching fabric, wherein from the step of generating the first optical signal to the end of the step of generating another optical signal requires less than one millisecond more than the time it takes the optical signal to reach the second other node and return therefrom.

76. A method according to claim 74 including the step of:
configuring the switching fabric for propagating of the another optical signal within the timeslot/wavelength channel pairing prior to transmission thereof.

77. A method of allocating resources within an optical network comprising the steps of:
a) providing a same data signal modulated within each of a plurality of different optical signals within at least one timeslot/wavelength channel pairing within a same optical waveguide, the data signal for transmission from a source to a destination;
b) propagating at least one of the different optical signals from the source to the destination within a timeslot/wavelength channel pairing without buffering the data modulated therein; and,
c) attenuating at least another of the plurality of different optical signals to prevent propagating thereof from the source to the destination.

78. A method according to claim 77 wherein the step of propagating is performed absent converting the at least one of the different optical signals to another carrier wavelength.

79. A method according to claim 77 wherein the step (a) providing a same data signal includes the step of transmitting the provided same data signals approximately simultaneously one to another.

80. A method according to claim 77 wherein the step (a) providing a same data signal includes the step of transmitting the provided same data signals in different timeslots, one after another.

81. A method according to claim 77 wherein the steps of (b) and (c) include the steps of:
when the timeslot/wavelength channel pairing within an optical path is available propagating the at least one of the different optical signals within the switching fabric to the destination absent a step of opto-electronic conversion and absent a step of wavelength conversion and receiving the at least one of the different optical signals at the destination; and,
when the timeslot/wavelength channel pairing within the optical path is unavailable attenuating the at least another of the plurality of different optical signals within the switching fabric to prevent interference therewith.

82. A method according to claim 77 wherein the step of propagating at least one of the different optical signals from the source to the destination comprises the steps of:
providing the at least one of the different optical signals in each of several optical communication paths within at least a timeslot/wavelength channel pairing; and,
performing within each path independently one of blocking the at least one of the different optical signals and other than blocking the at least one of the different optical signals.

83. A method according to claim 77 wherein the step of propagating at least one of the different optical signals from the source to the destination comprises the steps of:
providing the at least one of the different optical signals in each of several optical communication paths within at least a timeslot/wavelength channel pairing; and,
performing within each path in an interdependent fashion one of blocking the at least one of the different optical signals and other than blocking the at least one of the different optical signals.

84. A method according to claim 77 wherein the light source is one of a plurality of light sources each dedicated to generating light within a different known optical wavelength channel.
